(19) United States
(12) Patent Application Publication
(10) Pub. No.: US 2008/0199554 A1
(43) Pub. Date: Aug. 21, 2008

(54) METHOD AND APPARATUS FOR COUPLING MELT CONDUITS IN A MOLDING SYSTEM AND/OR A RUNNER SYSTEM

(75) Inventors: Jan Marius Manda, Toronto (CA); Graetz Josef, Erin (CA); Gregory Ray Hammond, Georgetown (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/954,363

(22) Filed: Dec. 12, 2007

Related U.S. Application Data
(63) Continuation-in-part of application No. 10/846,516, filed on May 17, 2004.

(51) Int. Cl. B29C 45/27

(52) U.S. Cl. 425/192 R

(57) ABSTRACT

Disclosed is a hot runner for conveying a metallic-molding material. The hot runner includes: (i) a first conduit, and (ii) a second conduit. The first conduit is configured to receive the metallic-molding material. The second conduit is configured to receive the metallic-molding material from the first conduit. The first conduit is thermally expandable relative to the second conduit sufficiently enough so that an interference seal forms between the first conduit and the second conduit. The interference seal substantially prevents a leakage of the metallic-molding material from the first conduit and the second conduit.

### CROSS REFERENCE TO RELATED APPLICATION

This patent application is a continuation-in-part patent application of prior U.S. patent application Ser. No. 10/846,516 filed, 17 May 2005. This patent application also claims the benefit and priority date of prior U.S. patent application Ser. No. 10/846,516, filed 17 May 2005.

### TECHNICAL FIELD

The present invention generally relates to metal-injection molding systems. In particular, the present invention relates to hot runners for metal-injection molding systems.

### BACKGROUND

The present invention is concerned with the molding of a metal alloy (such as Magnesium) in a semi-solid or fully liquid (i.e. above solidus) state. Detailed descriptions of exemplary apparatus and operations of injection molding systems used for such alloys are available with reference to U.S. Pat. Nos. 5,040,589 and 6,494,703.

FIGS. 1 and 2 show a known injection molding system 10 including an injection unit 14 and a clap unit 12 that are coupled together. The injection unit 14 processes a solid metal feedstock (not shown) into a melt and subsequently injects the melt into a closed and clamped injection mold arranged in fluid communication therewith. The injection mold is shown in an open configuration in FIG. 1 and comprises complementary mold hot and cold halves 23 and 25. The injection unit 14 further includes an injection unit base 28 which slidably supports an injection assembly 29 mounted thereon. The injection assembly 29 comprises a barrel assembly 38 arranged within a carriage assembly 34, and a drive assembly 36 mounted to the carriage assembly 34. The drive assembly 36 is mounted directly behind the barrel assembly 38, for the operation (i.e., rotation and reciprocation) of a screw 56 (FIG. 2) arranged within the barrel assembly 38. The injection assembly 29 is shown to be connected to a stationary platen 16 of the clamp unit 12, through the use of carriage cylinders 30. The carriage cylinders 30 are configured to apply, in operation, a carriage force along the barrel assembly 38 for maintaining engagement between a machine nozzle 44 (FIG. 2), of the barrel assembly 38, within a melt conduit (e.g., sprue bushing, manifold 170, etc.), of a hot half runner system 26, whilst the melt is being injected into the mold (i.e., acts against the reaction forces generated by the injection of the melt). The connection between the machine nozzle 44 and the melt conduit of the runner system is preferably a spigot connection, as described in U.S. Pat. No. 6,357,511.

The barrel assembly 38, in FIG. 2, is shown to include an elongated cylindrical barrel 40 with an axial cylindrical bore 48A arranged therethrough. The bore 48A is configured to cooperate with the screw 56 arranged therein, for processing and transporting the metal feedstock, and for accumulating and subsequently channeling a melt of molding material during injection thereof. The screw 56 includes a helical flight 58 arranged about an elongate cylindrical body portion 59 thereof. A rear portion (not shown) of the screw 56 is preferably configured to couple with the drive assembly 36. A forward portion of the screw (also shown) is configured to receive a non-return valve 60 with an operative portion thereof arranged in front of a forward mating face of the screw 56. The barrel assembly 38 also includes a barrel head 42 that is positioned intermediate the machine nozzle 44 and a front end of the barrel 40. The barrel head 42 includes a melt passageway 48B arranged therethrough that connects the barrel bore 48A with a complementary melt passageway 48C arranged through the machine nozzle 44. The melt passageway 48B trough the barrel head 42 includes an inwardly tapering portion to transition the diameter of the melt passageway to the much narrower melt passageway 48C of the machine nozzle 44. The central bore 48A of the barrel 40 is also shown as including a liner 46 made from a corrosion resistant material, such as Stellite™, to protect the barrel substrate material, commonly made from a nickel-based alloy such as Inconel™, from the corrosive properties of the high temperature metal melt. Other portions of the barrel assembly 38 that come into contact with the molding material melt may also include similar protective linings or coatings.

The barrel 40 is further configured for connection with a source of comminuted metal feedstock through a feed throat (not shown) that is located through a top-rear portion of the barrel (also not shown). The feed throat directs the feedstock into the bore 48A of the barrel 40. The feedstock is then subsequently processed into a melt of molding material by the mechanical working thereof, by the action of the screw 56 in cooperation with the barrel bore 48A, and by controlled heating thereof. The heat is provided by a series of heaters 50 (not all of which are shown) that are arranged along a substantial portion of the length of the barrel assembly 38.

The clamp unit 12 includes a clamp base 18 with a stationary platen 16 securely retained to an end thereof, a clamp block 22 slidably connected at an opposite end of the clamp base 18, and a moving platen 20 arranged to translate therebetween on a set of tie bars 32 that otherwise interconnect the stationary platen 16 and the clamp block 22. As is known, the clamp unit 12 further includes a means for stroking (not shown) the moving platen 20 with respect to the stationary platen to open and close the injection mold halves 23, 25 arranged therebetween. A clamping means (not shown) is also provided between the clamp block and the moving platen to provide of a clamping force between the mold halves 23, 25 during the injection of the melt of molding material. The hot half of the injection mold 25 is mounted to a face of the stationary platen 16, whereas the complementary cold half of the mold 23 is mounted to an opposing face of the moving platen 20.

In further detail, the injection mold includes at least one molding cavity (not shown) formed between complementary molding inserts shared between the mold halves 23, 25. The mold cold half 23 includes a core plate assembly 24 with at least one core molding insert, not shown, arranged therein. The mold hot half 25 includes a cavity plate assembly 27, with at least one complementary cavity molding insert arranged therein, mounted to a face of a runner system 26. The hot runner system 26 provides a means for connecting the melt passageway 48C of the machine nozzle 44 with at least one molding cavity for the filling thereof. The runner system 26 includes a manifold plate 64 and a complementary backing plate 62 for enclosing melt conduits therebetween, and a thermal insulating plate 60. The runner system 26 may be an offset or multi-drop hot runner system, a cold runner system, a cold sprue system, or any other commonly known melt distribution means.

The process of molding a metal in the above-described system generally includes the steps of: (i) establishing an inflow of metal feedstock into the rear end portion of the barrel 40; (ii) working (i.e., shearing) and heating the metal feedstock into a thixotropic melt of molding material by: (iia) the operation (i.e., rotation and retraction) of the screw 56 that functions to transport the feedstock/melt, through the cooperation of the screw flights 58 with the axial bore 48A, along the length of the barrel 40, past the non-return valve 60, and into an accumulation region defined in front of the non-return valve 60; and (iib) heating the feedstock material as it travels along a substantial portion of the barrel assembly 38; (iii) closing and clamping the injection mold halves 23, 25; (iv) injecting the accumulated melt through the machine nozzle 44 and into the injection mold by a forward translation of the screw 56; (v) optionally filling any remaining voids in the molding cavity by the application of sustained injection pressure (i.e. densification); (vi) opening the injection mold, once the molded part has solidified through the cooling of the injection mold: (vii) removal of the molded part from the injection mold; (viii) optionally conditioning the injection mold for a subsequent molding cycle (e.g., application of mold release agent).

A major technical challenge that has plagued the development of a hot runner system 26, suitable for use in metal-injection molding, has been the provision of a substantially leak-free means for interconnecting the melt conduits therein. Experience has taught that the traditional connection regime used in a plastics hot runner system (i.e., a face-seal that is compressively loaded under the thermal expansion of the melt conduits) is not suitable in a hot runner system for metal molding. In particular, in a metal hot runner system, the extent to which the melt conduits must be compressed to maintain a face-seal therebetween is also generally sufficient to crush them (i.e., yielding occurs). This is partly the result of the high operational temperatures of the melt conduits (e.g., around 600° C. for a typical Mg alloy), which significantly reduces the mechanical properties of the component material (e.g., typically made from a hot work tool steel such as DIN 1.2888). Another problem is that significant thermal gradients exist across the melt conduits at the high operating temperature cause significant unpredictability in their geometry which complicates the selection of suitable cold clearances.

Another challenge with the configuration of structure for interconnecting melt conduits has been in accommodating the thermal growth of the interconnected melt conduits (i.e., as the conduits are heated between ambient and operating temperatures) without otherwise displacing functional portions thereof that may need to remain fixed relative to other structure. For example, in a single drop hot runner system, with an offset drop, wherein there are two melt conduits, namely a supply and a drop manifold, respectively, it is advantageous to fix the location of a machine nozzle receptacle portion of the supply manifold for sake of alignment with the machine nozzle 44, while also fixing a drop (i.e., discharge) portion of the drop manifold for sake of alignment with an inlet gate of a molding cavity insert. Accordingly, some means for sealing between the supply and drop manifolds must be provided that accommodates an expansion gap therebetween in the cold condition, and that does not rely on a face-seal therebetween in the hot condition. This becomes even more of a challenge in a multi-drop hot runner (i.e., a hot runner with more than one discharge nozzle for servicing a large molding cavity or a mold with more than one molding cavity) wherein there are many fixed drop portions, the drop portions being configured on a corresponding quantity of drop manifolds.

### SUMMARY

According to a first aspect of the present invention, there is provided a hot runner for conveying a metallic-molding material. The hot runner includes: (i) a first conduit, and (ii) a second conduit. The first conduit is configured to receive the metallic-molding material. The second conduit is configured to receive the metallic-molding material from the first conduit. The first conduit is thermally expandable relative to the second conduit sufficiently enough so that an interference seal forms between the first conduit and the second conduit.

A technical effect associated with the first aspect is that the interference seal substantially prevents a leakage of the metallic-molding material from the first conduit and the second conduit, thus reducing wastage of the metallic-molding material, and generally improving operational efficiency of the hot runner.

### DESCRIPTION OF THE DRAWINGS

A better understanding of the non-limiting embodiments of the present invention (including alternatives and/or variations thereof) may be obtained with reference to the detailed description of the non-limiting embodiments along with the following drawings, in which:

FIG. 1 depicts a schematic representation of an injection molding machine;

FIG. 2 depicts a partial section of a portion of the injection molding machine of FIG. 1;

FIGS. 3A and 3B, comprise schematic plan and cross-section views of a first embodiment of the present invention;

FIGS. 4A and 4B comprise perspective and cross-section views of an alternative embodiment of the present invention;

FIG. 5 is a cross-section of another alternative embodiment of the present invention;

FIG. 6 is a perspective view of an embodiment of the present invention used in an injection mold hot half;

FIG. 7 is a cross-section of the FIG. 6 embodiment;

FIGS. 8A and 8B comprise perspective and cross-section views of the supply manifold shown in FIGS. 6 and 7;

FIGS. 9A and 9B comprise perspective and cross-section views of the drop manifold shown in FIGS. 6 and 7;

FIG. 10 is a perspective view of another embodiment of the present invention used in an injection mold hot half;

FIG. 11 is a cross-section of the FIG. 10 embodiment;

FIGS. 12A and 12B comprise perspective and cross-section views of the supply manifold shown in FIGS. 10 and 11;

FIG. 13 depicts a schematic representation of a hot runner 1000 according to another non-limiting embodiment;

FIGS. 14A to 14E depict cross-sectional views of a first non-limiting variant of the hot runner 1000 of FIG. 13;

FIGS. 15A to 15D depict cross-sectional views of a second non-limiting variant of the hot runner 1000 of FIG. 13;

FIGS. 16A to 16C depict cross-sectional views of a third non-limiting variant of the hot runner 1000 of FIG. 13;

FIGS. 17A to 17C depict cross-sectional views of a fourth non-limiting variant of the hot runner 1000 of FIG. 13;

FIG. 18A to 18G depict cross-sectional views of a fifth non-limiting variant of the hot runner 1000 of FIG. 13;

FIGS. 19A to 19F depict cross-sectional views of a sixth non-limiting variant of the hot runner 1000 of FIG. 13;

FIGS. 20A to 20D depict cross-sectional views of a seventh non-limiting variant of the hot runner 1000 of FIG. 13;

FIGS. 21A to 21D depict cross-sectional views of an eighth non-limiting variant of the hot runner 1000 of FIG. 13; and

FIGS. 22A to 22C depict cross-sectional views of a ninth non-limiting variant of the hot runner 1000 of FIG. 13.

### DETAILED DESCRIPTION OF THE NON-LIMITING EMBODIMENTS

### Introduction

The present invention will now be described with respect to several embodiments in which an injection molding system is used for the molding of a metal alloy, such as Magnesium, above its solidus temperature (i.e., semi-solid thixotropic, or liquidus state). However, the present invention may find use in other injection molding applications such as plastic, liquid metal, composites, powder injection molding, etc.

Briefly, in accordance with the present invention, a melt conduit coupler is provided for interconnecting discrete melt conduits. Preferably, complementary male and female ‘spigot’ coupling portions are arranged on each of a melt conduit coupler and along portions of the melt conduits to be interconnected, respectively. A ‘spigot’, as used in this description, is a modifier that characterizes the relative configuration of pairs of complementary coupling portions that cooperate to interconnect discrete melt conduits in a substantially leak-five manner. In particular, a complementary pair of ‘spigot’ coupling portions are characterized in that the coupling portions are configured to cooperate in an overlapping, closely-spaced, and mutually parallel relation. The spigot coupling portions are preferably configured to cooperate to provide a ‘spigot connection’ between each of the melt conduit spigot coupling portions and the complementary spigot coupling portion provided on the melt conduit coupler. The ‘spigot connection’ is characterized in that the interface between the complementary spigot coupling portions is cooled. Accordingly, a spigot connection is provided as a cooled engagement between closely-fit complementary cylindrical sealing faces, wherein a weepage or leakage of melt therebetween solidifies to provide a further effective seal that substantially prevents further leakage of melt.

The invention provides a new use for a spigot connection that solves some rather vexing problems in metal molding runner systems, outlined hereinbefore. U.S. Pat. No. 6,357,511, discloses a spigot connection configured between a machine nozzle and a mold sprue bushing. Of the present invention, a melt conduit coupler has been devised that uses the spigot connection to interconnect pairs of melt conduits. The presently preferred form of the invention is as an interconnection between a pair of melt conduits.

Furthermore, a runner system may also make use of the inventive melt conduit coupler to join typical melt distribution manifolds contained therein. For example, a single drop hot runner, in an offset configuration, is disclosed herein that is particularly useful in adapting cold chamber die casting molds for use in a metal-injection molding machine. Also disclosed is a multi-drop hot runner for use in a metal-injection molding machine.

In a preferred embodiment of the invention each of the melt conduits includes a spigot coupling portion that is provided on an outer circumferential surface that is arranged along a cylindrical end portion thereof. Similarly, the melt conduit coupler preferably comprises a cooled ring body wherein a complementary spigot coupling portion is arranged along an inner circumferential surface thereon. The ring body is preferably configured for the cooling thereof, in use, to maintain the required temperature at the spigot connection (i.e., provide a seal of relatively cooled, solidified melt). As one example, the temperature of the melt conduit coupler is controlled, in use, to maintain the temperature at the spigot connection at about 350° C., when molding with a typical Magnesium alloy melt.

In the following description, the mold operating temperature is typically around 200-230° C., the melt temperature is typically around 600° C.; hot work tool steel (DIN 1.2888) is preferably used for manifolds, spigot tip inserts, etc. Also, the sealing/cooling rings are preferably made from regular tool steel (AISI 4140, or P20) because they are kept at a relatively low temperature and are generally isolated from large forces. Alternatively, the sealing/cooling rings can be made from AISI H13 where some force transmission is expected. The manifold insulators are preferably made from a relatively low thermally conductive material that is also capable of withstanding the extremely high processing temperatures without annealing. Presently, the preferred insulators am made from Inconel™. However, the actual mold operating temperature, melt temperature, tool steel, sealing/cooling ring material, and manifold insulators may be selected based on the material being molded, the required cycle times, the available materials, etc. All such alternate configurations are to be included within the scope of the attached claims.

### Spigot Seal Parameters

In accordance with the preferred embodiment, a melt conduit coupler is provided for interconnecting discrete melt conduits. Accordingly, spigot coupling portions are arranged on each of the melt conduit couplers and along portions of the melt conduits that are to be interconnected. Preferably, the fit between the complementary spigot coupling portions includes a small diametrical gap. The small gap provides for ease of engagement between the complementary coupling portions during assembly. Preferably, the gap is designed so that it is taken-up by the relative expansion of the spigot coupling portions when the melt conduits and the melt coupler are at their operating temperatures. Any diametrical interference between the spigot coupling portions at their operating temperatures may provide supplemental sealing, but is not otherwise relied upon.

In the presently preferred embodiments, a typical gap between the coupling portions is about 0.1 mm per side when the melt conduits and the melt conduit coupler are at ambient temperature. However, this 0.1 mm gap is not essential, the fit between the complementary spigot coupling portions could otherwise be exact or include a slight interference at ambient temperature. Preferably, each melt conduit coupler is independently temperature-controlled.

As will be described in detail hereinafter, active cooling of the melt conduit coupler is preferred to control the temperature at the interface between the spigot coupling portions to maintain a substantially leak-free spigot connection. However, by configuring the melt conduit within cooled runner system plates (manifold and manifold backing plates which are maintained at about 200-230° C.) it may also be possible to rely solely on passive heat transfer therewith. Preferably, the melt conduit components to be interconnected are arranged in the melt conduit coupler such there is a longitudinal cold clearance therebetween when the melt conduit components are at ambient temperate. In particular, there is a cold clearance gap between complementary annular mating faces that are disposed at the ends of each of the complementary melt conduits when the melt conduits are at ambient temperature.

Preferably, the clearance between the mating faces is taken up when the melt conduits are at their operating temperatures, due to the thermal expansion thereof. Accordingly, the preload between the mating faces of the melt conduit components, if any, can be controlled to avoid excessive compressive forces that could otherwise crush the melt conduit components. In the preferred embodiments, a typical cold clearance for a melt conduit that is heated to 600° C. is about 1 mm. Any face-seal that is provided between the complementary mating faces, at operating temperature, is supplemental.

### The First Embodiment

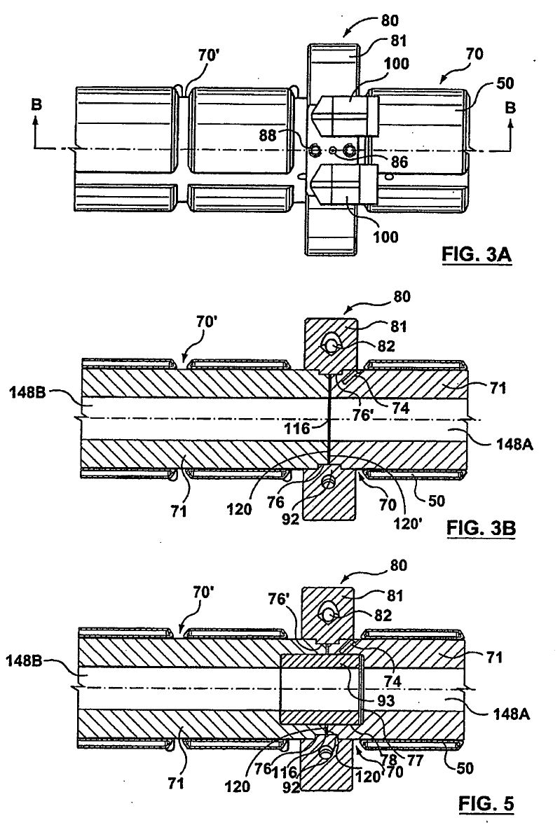

With reference to FIGS. 3A and 3B, the first embodiment of the present invention is shown. A first melt conduit 70 and a second melt conduit 70′ (respectively containing melt channels 148A and 148B) are interconnected by a melt conduit coupler 80. The melt conduit coupler 80 is, in a simple form, an annular body 81 having a coolant passage or passages 82 therein, which can be seen in FIG. 3B. Two coolant fittings 100 are provided for the inlet and outlet of the coolant passage(s). The coolant passage(s) 82 are preferably connected to a source of coolant, typically air, that maintains the temperature of the melt conduit coupler 80 somewhere around 350° C. However, other coolants such as oil, water, gasses, etc. way be used, depending upon the molding application. Note that 350° C. is relatively cool when compared to the melt conduits, which typically are maintained somewhere around 600° C., for Magnesium alloy molding.

The melt conduit coupler 80 is also shown to include a thermocouple installation 86 that includes a bore that is configured for receiving a thermocouple. Adjacent to the thermocouple installation is a thermocouple retainer 88 that includes a bore that is configured to receive a fastener, the fastener retains, in use, a clamp (not shown) that retains the thermocouple within the thermocouple installation 86. Preferably, the thermocouple installation 86 is located very close to a spigot coupling portion 76′ disposed around an inner circumferential surface of the melt conduit coupler 80 so that the temperature at a spigot connection with complementary spigot coupling portions 76, disposed around end portions of the melt conduits 70, 70′, can be controlled. Each of the melt conduits 70, 70′ may have a heater 50 to maintain the temperature in the melt in conduits at the prescribed operating temperature, which again is about 600° C. for Magnesium alloy molding.

FIG. 3B shows a schematic cross-section of the melt conduit coupler 80. The preferred embodiment uses a spigot connection between the melt conduit coupler 80 and the end portions of the melt conduits 70, 70′. Preferably, an inner circumferential surface of the annular body 81 and an outside circumferential surface of end portions of the melt conduits 70, 70′, that are to be interconnected, are given a complementary configuration wherein the location of the melt conduit coupler 80 substantially fixed about the interface between the melt conduits 70, 70′. Accordingly, complementary shoulder portions are configured around the outside circumferential surface at the end portions of the melt conduits 70, 70′ and around an inner circumferential surface of the melt conduit coupler 80, respectively. The melt conduit coupler 80 is configured to include a pair of the shoulder portions, one for each of the melt conduits 70, 70′ that are to be interconnected, and are configured at opposing ends of the inner circumferential surface of the melt conduit coupler 80, the shoulder portions being separated by a residual annular portion 92. The complementary spigot coupling portions 76, 76′ are configured across an outside circumferential surface of a recessed portion of the shoulder, and across the inner circumferential surface of the annular portion 92, on the melt conduit couplers 70, 70′ and the melt conduit coupler 80, respectively. Of course, the coupling may eliminate the complementary shoulder portions, or may incorporate any number and/or shape of protruding and recessed surfaces to enhance coupling, depending upon the molding application.

As described hereinbefore, the spigot coupling portions 76, 76′ are preferably configured to have a small gap therebetween. In use, a Magnesium alloy at 600° C. has a viscosity like water and is therefore generally able to seep between complementary mating faces 120, 120′ of the melt conduits 70, 70′, and to thereafter seep between spigot coupling portions 76, 76′. However, because the melt conduit coupler 80 is kept at a relatively low temperature by active or passive cooling (i.e., around 350° C.), the melt will fully or at least partially solidify in such gaps and provide a seal that substantially prevents the further leakage of melt.

A thermocouple 74 may be disposed at the end portions of either or both of the melt conduits 70, 70′, to detect the temperature of the melt conduit adjacent the melt conduit coupler 80. Preferably, the thermocouple 74 is located very close to the interface between the spigot coupling portions 76, 76′, so that the temperature of the melt within the melt passageway 148A, 148B adjacent the spigot connection can be controlled (for example, by controlling the power to the heaters 50 disposed about the melt conduits 70, 70′), to prevent the formation of a plug in the melt passageway 148A, 148B adjacent the cooled spigot connection.

The mating faces 120, 120′ of the melt conduits 70 and 70′ are shown to preferably include a longitudinal cold clearance 116 of about 1 mm therebetween when the melt conduits are at that ambient temperature. This gap is selected (predetermined) to be taken up (or substantially closed) as the melt conduits expand in length as they are heated to the operating temperatures. Accordingly, there is substantially no gap, and maybe even some compression between the mating faces of the melt conduits 70 and 70′. Any such compression may act to provide a supplemental seal against leakage of melt. In this fashion, excessive compressive forces between the melt conduits 70, 70′, due to thermal expansion, that may otherwise cause local yielding in the melt conduits 70, 70′ is substantially avoided.

As discussed above, the melt also has a way of working its way through the gaps between the spigot coupling surfaces 76, 76′, and is only substantially prevented by carefully controlling the temperature at the interface between these spigot coupling portions 76, 76′ well below the melting point of the molding material. For the preferred embodiments, it is preferable that a cold clearance gap of about 0.1 mm between the spigot coupling portions 76, 76′ be provided at ambient temperature. In use, the relative thermal expansion of the melt conduit coupler 80 and the melt conduits 70, 70′ is such that this diametrical gap will be substantially taken up and preferably there is as an intimate contact between the accompanying portions at the operating temperature. Such intimate contact would provide a supplemental seal against further leakage of the melt, although a small residual gap is tolerable in view of the main mode of sealing (i.e. seal of solidified melt). Alternatively, there could be an exact fit, or even a small compressive preload between the spigot coupling portions 76, 76′ at ambient temperature. This would ensure that there is supplemental sealing from the compression between the spigot coupling portions 76, 76′ at the operating temperatures. Accordingly, the melt coupler 80 of the present invention provides a substantially leak-free seal between melt conduits 70, 70′ that operates without requiring a compressive sealing force between the mating faces 120, 120′ of the melt conduits 70, 70′.

In, an alternative embodiment (not shown), the melt conduit coupler may be integrated onto an end of one of the melt conduits.

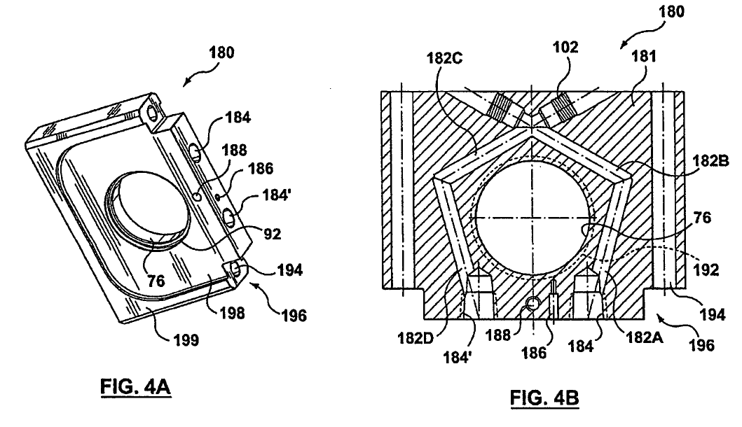

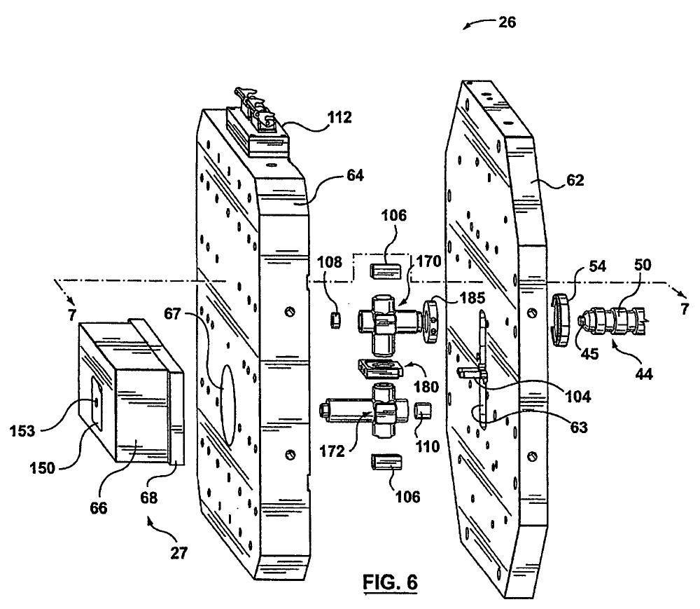

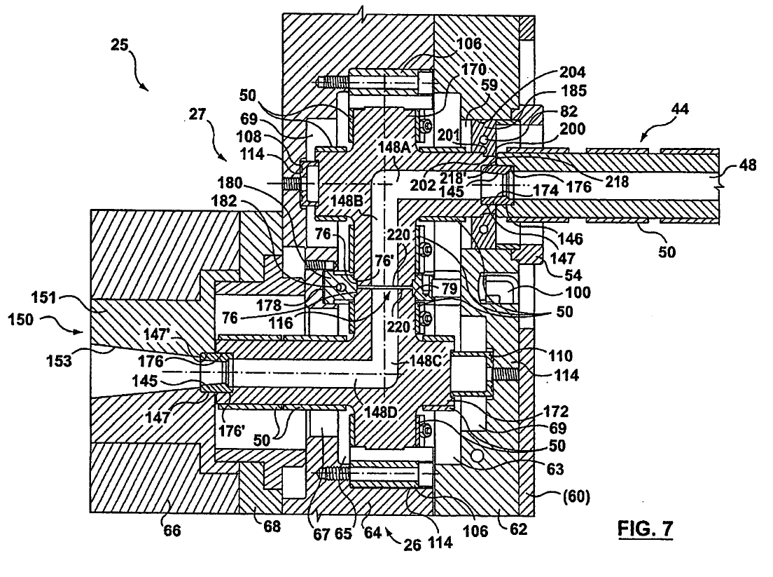

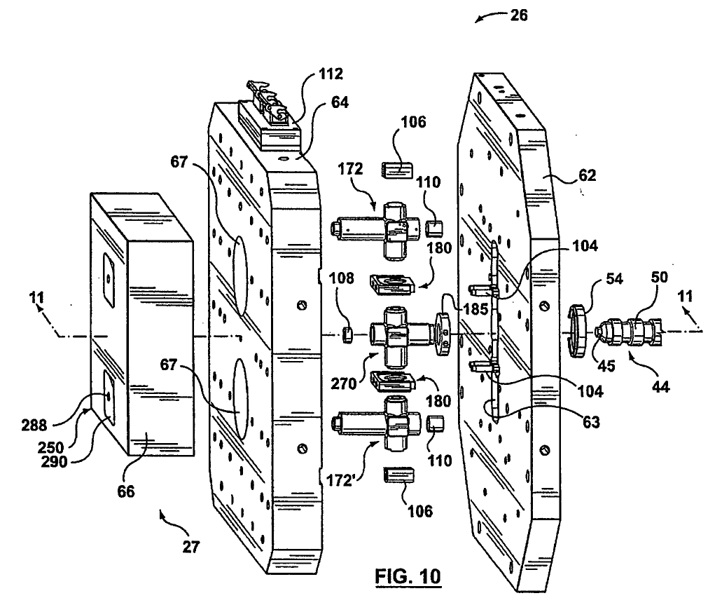

In, an alternative embodiment, the melt conduit coupler 180 is a parallelepiped, as shown with reference to FIGS. 4A and 4B. Accordingly, the outer surface of the melt conduit coupler 180 is rectangular, and a central cylindrical passageway configured therethrough is configured in a consistent manner as the prior embodiment with reference to FIGS. 3A and 3B. The rectangular body 181 of the melt conduit coupler 180 is more easily integrated, that is retained, within the plates of a hot runner system, as shown with reference to FIG. 6 and in FIG. 10. Preferably, the rectangular body 181 is configured to be retained in a complementary formed pocket provided in a hot runner plate (e.g. with reference to FIG. 7, the hot runner plates include a manifold plate 64 or a backing plate 62). As will be explained in detail hereinafter, the hot runner plates provide a housing for the melt conduits 70, 70′ (or ‘manifolds’, as more commonly known), the melt conduit couplers 80, and all the other related components.

As previously mentioned, the specific features of the melt conduit coupler 180 are substantially similar to those discussed above with respect to melt conduit coupler 80 in FIGS. 3A and 3B. The spigot coupling portion 76 is provided on the inner circumferential surface of an annular portion 192, and also provided are shoulder portions configured on each side of the annular portion 192 that cooperate, in use, with complementary shoulder portions configured on the end portions of the melt conduits, or manifolds, to generally retain the melt conduit coupler 180. A coolant passageway 182 preferably comprises various drilled portions so there is a first coolant passage portion 182A, a second coolant passage portion 182B, a third coolant passage portion 182C, and a fourth coolant passage portion 182D. Preferably, the coolant passage portions are formed by drilling and the drill entrances may be plugged with plugs 102, as required. Coolant ports 184 and 184′ are provided in communication with the coolant passageways 182 for receiving coupling fittings 100. As before, a thermocouple may be installed within a thermocouple installation 186, in proximity to the complementary spigot coupling portion 76 such that the temperature of the spigot connection can be closely monitored and the temperature and/or flow of the coolant can be adjusted accordingly. Preferably, the coolant is conditioned outside of the mold through the use of a Thermolator™ heating/cooling unit, as required. Again, a thermocouple retainer is provided adjacent to the thermocouple installation 186 to receive a fastener that fastens a clamp (not shown) for retaining the thermocouple within the thermocouple installation 186.

Also shown in FIG. 4A are a pair of cylindrical bores 194 that are configured on either side of the central opening in the melt conduit coupler 80, and that are substantially perpendicular to an axis thereof. In addition, a cut-out 196 is configured at the first end of each of the cylindrical bores 194, on an end of the rectangular body 181. The cylindrical bores 194 and the cutout 196 provide a structure that cooperates with a shank and a head of a fastener, respectively, such as a socket head cap screw, such that the melt conduit coupler 180 can be retained within the pocket provided in a hot runner plate (e.g. the manifold plate 64 with reference to FIG. 7).

Also shown in FIG. 4A is a pocket surface 198 on each face 199 of the melt conduit coupler 180. The faces 199 are in contact with the surfaces of the pocket within the hot runner plate and control the amount of heat transfer therebetween. The larger the contact surface between the faces 199 of the melt conduit coupler 180 and the pocket, the more heat transfer between the two. Accordingly, the preferred design uses pocket surfaces 198 to minimize the contact surface between the faces 199 and the pocket in the hot runner plate so that the temperature at the spigot coupling portion 76, 76′ may be more precisely controlled by influence of the coolant flow within the coolant passage 182.

### Supplemental Expansion Bushing

With reference to FIG. 5, an alternative embodiment of the present invention is shown. Structures which are the same as those shown in FIG. 3B are designated by the same reference numbers. In FIG. 5, a expansion bushing 93 is provided to provide a supplemental seal between the melt conduits 70, 70′. Preferably, the expansion bushing is provided by an annular ring. An outside circumferential surface of the annular ring is configured to cooperate with a bushing seat 78 that is provided along an inner circumferential surface of a cylindrical bore that is formed through the end portions of the melt conduits 70, 70′, concentric with the melt passageways 148A, and 148B. The inner circumferential surface of the expansion bushing connects the melt passageways 148A and 148B, and preferably has the same diameter. Preferably, the supplemental expansion bushing 93 is made from a metal which is different from that of the melt conduits whereby a compressive sealing force is developed between the outside surface of the expansion bushing 93 and the bushing seat 78 as a result of the relative thermal expansion of the expansion bushing 93 and the melt conduits 70, 70′. Preferably, the supplemental expansion bushing 93 is made from a material, like Stellite™ (a Cobalt-based alloy), which will grow slightly more per given temperature change than the melt conduits that may be made from DIN 1.2888. As the bushing seat 78 will also expand in length, a longitudinal cold clearance is preferably provided between the ends of the expansion bushing and the corresponding end of the seats to the extent that a portion of the gap remains even when the melt conduits 70, 70′ are at their operating temperature such that the expansion bushing 93 does not act to separate the melt conduits 70, 70′.

### Use in Offset Applications

With reference to FIGS. 6 and 7, an injection mold hot half 25 is shown as including a single drop hot runner 26, with an offset drop, and a cavity plate assembly 27. The hot half 25 is preferably configured to accommodate a cavity molding insert (not shown). The hot runner 26 is useful in adapting molds that were intended for use in cold chamber die casting machine for use in an injection molding machine. In particular, many such molds include an offset injection portion (not shown) that is otherwise required to prevent the free-flow of melt into the mold cavity during an initial “slow shot” that purges air from the cold chamber. Thus, in order to center the cavity in die-casting machines, the injection point is situated offset from the center of the mold. Also, offset injection points may be necessary for parts that have to be filled from outside in. The hot runner includes a backing plate 62 and a manifold plate 64, with the melt conduit component and other auxiliary components housed therebetween. The hot runner 26 includes two melt conduits, namely a supply manifold 170 and a drop manifold 172. Both the supply and drop manifolds 170, 172 are configured to include right angle melt passageways therein, as shown in detail in FIGS. 5A, 8B, 9A, and 9B.

The supply and drop manifolds 170 and 172 are preferably interconnected with a melt conduit coupler 180. Preferably, the manifolds themselves are located in manifold pockets 65 provided in the manifold plate 64 and as shown with reference to FIG. 7. The manifolds 170, 172 are also configured to receive side insulator 106 and axial insulators 108 and 110 that substantially isolate the heated manifolds from the relatively cooler plates and to transfer axial loads thereto. Also shown in FIG. 6 are coolant conduits 104 that are configured to connect with the coolant ports 184, 184′ on the melt conduit coupler 180. Also shown in the backing plate 62 is a services pocket 63, which provides a clearance for portions of the manifolds 170, 172, wiring for the thermocouples and heaters, the coolant conduits, and other auxiliary components.

Also shown in FIG. 6 is a cooling ring 185 which cools the inlet portion of the supply manifold 170. Cooling the inlet portion will assist in making a spigot connection between a spigot coupling portion 174 of a nozzle seat that is configured through the inlet portion of the supply manifold 172, and described in detail hereinafter, and a complementary spigot portion 45 provided on the machine nozzle 44. Such a configuration is generally known with reference to U.S. Pat. No. 6,357,511. The cooling ring 185 comprises an annular coupling body with coolant passage(s) configured therein.

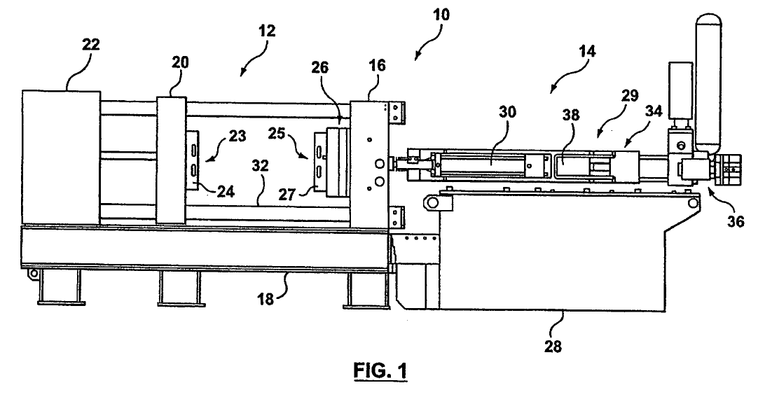

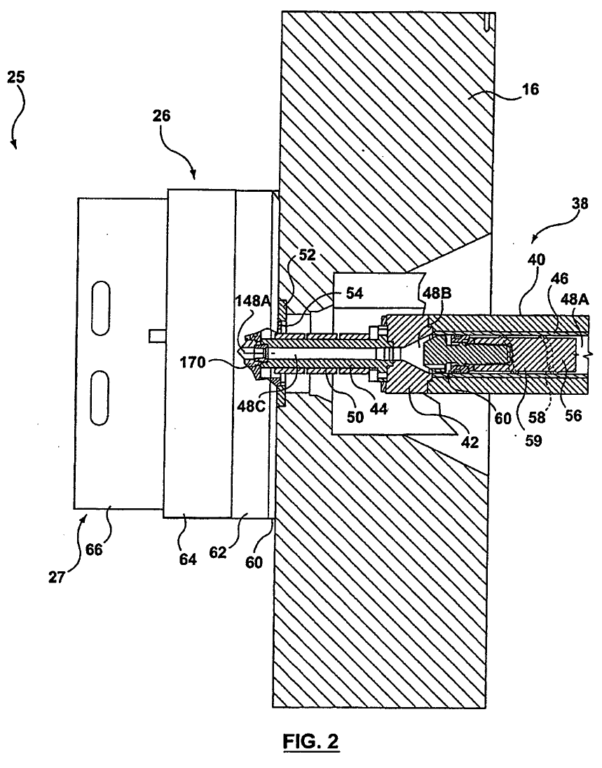

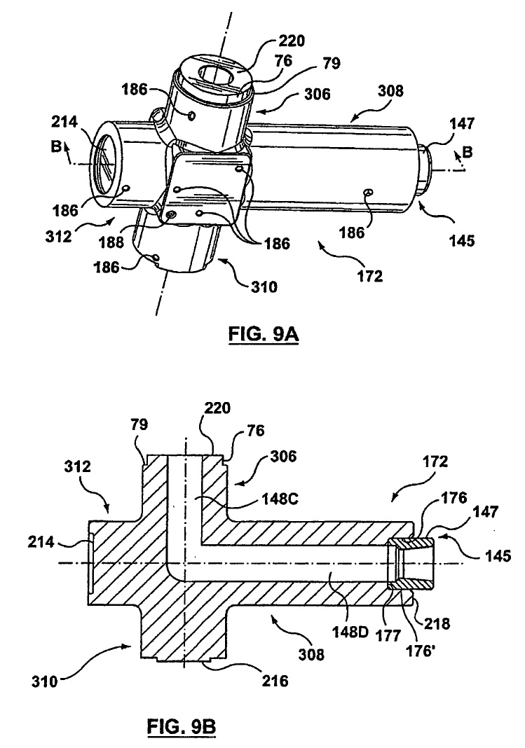

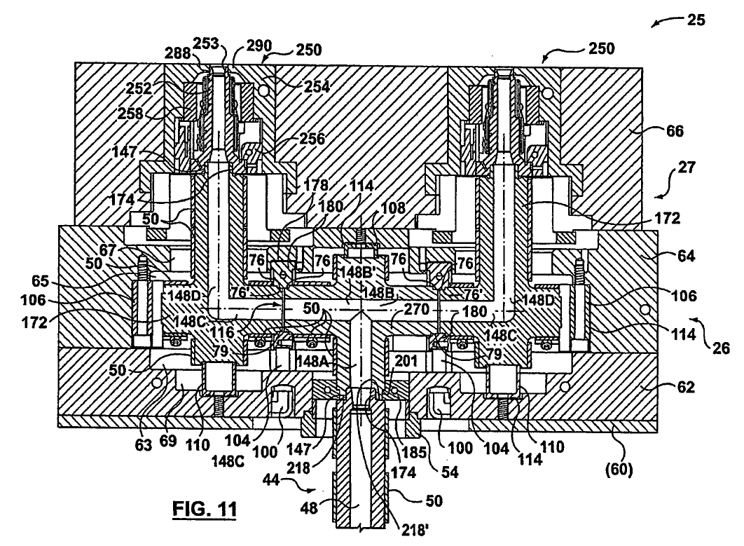

Also shown in FIG. 6 is a mold locating ring 54, that is configured to cooperate with a complementary locating ring (not shown) that is provided in the stationary platen 16 (FIG. 1) of the injection molding machine clamp 12 (FIG. 1) for aligning the nozzle seat of the supply manifold 170 with the machine nozzle 44 (FIG. 2). The cavity plate assembly 27, in further detail, comprises a cavity plate 66 and a spacer plate 68. A cavity molding insert (not shown) may be connected to a front face of the cavity plate 66. Also provided in the cavity plate 66 is a modified mold cold sprue 150 that comprises a sprue bushing 151 in which an outwardly tapering sprue passageway 153 is configured for the discharge of melt therethrough. The mold cold sprue 150 could be otherwise be a drop nozzle assembly 250, as will be explained later with reference to the embodiment of FIG. 10. The spacer plate 68 is simply an intermediate plate that spans a gap between the hot runner 26 and the cavity plate 66 that is otherwise dictated by the length of the discharge portion (the second elbow portion 308 as shown with reference to FIGS. 9A and 9B). The length of the discharge portion was established to ensure its versatility for use with a drop nozzle assembly 250 (FIG. 11). Preferably, the manifold plate 64 is provided with a drop passage 67 through which extends the discharge portion of the drop manifold 172.

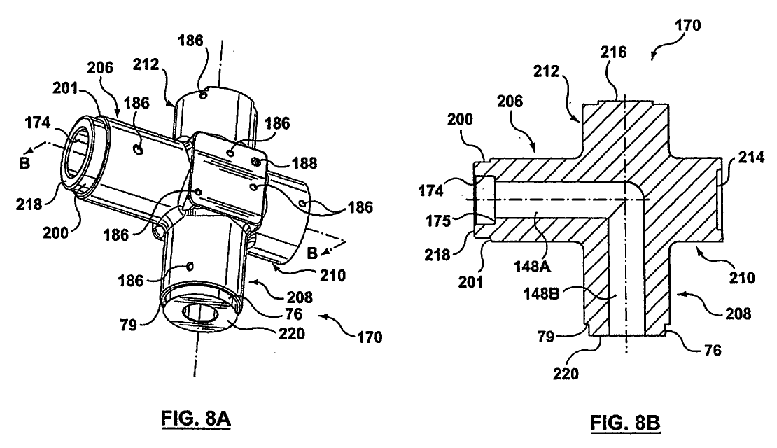

With reference to FIGS. 8A and 8B, the supply manifold 170 is shown in greater detail. The supply manifold 170 preferably has a cross-like shape and includes four structural portions; a first elbow portion 206, a second elbow portion 208, a third elbow portion 210, and a fourth elbow portion 212. Each of the elbow portions 206, 208, 210, and 212 is configured to serve a unique function. The first elbow portion 206 is essentially an inlet portion that is configured for interconnection with the machine nozzle 44 for connecting, in use, the machine nozzle melt passageway 48C with a melt passageway 148A of the first elbow portion 206. The first and second elbow portions 206, 208 are configured to be substantially perpendicular to one another. Accordingly, the second elbow portion 208 includes a melt passageway 148B extending therealong that is configured to cooperate with the melt passageway 148A of the first elbow portion 206 for substantially redirecting the melt traveling therethrough. The second elbow portion 208 is further configured for interconnection with an adjacent drop manifold 172 through the use of a melt conduit coupler 80. The third elbow portion 210, which is generally aligned with the first elbow portion 206, is configured for locating the supply manifold 170 within the plates 62, 64 along a first axis, and for transferring loads thereto. The fourth elbow portion 212, which is substantially perpendicular to the third elbow portion 210 and is generally aligned with the second elbow portion 208, is also configured for locating the supply manifold 170 within the plates 62, 64 along a second axis, and again for transferring loads thereto. Each of the elbow portions is preferably configured as a generally cylindrical body.

With reference to FIG. 8B, the first elbow portion 206 includes the melt passageway 148A that extends from a free end of the first elbow portion 206 along the length of the first elbow portion where it interconnects with the melt passageway 148B that is provided along the second elbow portion 208. Also provided at the free end of the first elbow portion 206 is a shallow cylindrical bore that provides a seat for receiving a spigot tip of the machine nozzle 44. Accordingly, an inner circumferential surface of the seat provides a spigot-mating portion 174. Preferably, a gap is configured between the shoulder 175 at the base of the seat and a front face of the spigot portion 45 when it is fully engaged within the seat. Accordingly, an annular face 218 provided at the free end of the first elbow portion 206 provides a spigot mating face that is configured to cooperate with a complementary mating face provided on the machine nozzle 44 for limiting the longitudinal engagement of the spigot portion 45 of the machine nozzle 44 into the seat, and may otherwise provide a supplemental face seal to prevent the leakage of melt of molding material. Also shown, is a seat that is configured along a shallow diametrical relief provided in the outer circumferential surface of the first elbow portion 206, immediately adjacent the free end thereof, for receiving the cooling ring 185. As previously described, the cooling ring 185 functions to cool interface between the spigot coupling portion 174 of the seat for providing a spigot seal with the complementary spigot coupling surface on the spigot portion 45 of the machine nozzle 44.

The cooling ring seat includes a mating portion 200 and a locating shoulder 201. The mating portion 200 preferably cooperates with a complementary mating portion provided on the cooling ring 185, to conduct heat between the supply manifold and the cooling ring for cooling the spigot coupling portion 174. Preferably, the locating shoulder 201 retains the cooling ring 185 adjacent the free end of the first elbow portion 206.

The cooling ring 185 is shown in FIGS. 6 and 7. It preferably comprises an annular body with a coolant channel configured therein. The coolant channel is coupled to a source of coolant in the same manner as the melt conduit coupler 80, as described above. The cooling ring is configured to cool the free end of the supply manifold 170 to ensure that the interface between the spigot tip 45 of the machine nozzle 44 and the spigot coupling portion 174 in the supply manifold is kept at or below the melting temperature of the melt, so that a seal of molding hardened or semi-hardened melt material is provided therebetween.

The remaining outer circumferential surface of the first elbow portion 206 is configured to receive a heater 50. The heater maintains the temperature of the melt in the melt passageway 148A at the prescribed operating temperature. A controller (not shown) controls the heater 50 through feedback from one or more thermocouples, located in thermocouple installation cavities 186, that monitor the temperature of the melt passageway 148A. The feedback from the thermocouples could also be used to control the temperature in the cooling ring 185. A thermocouple clamp retainer may be used to retain one or more of the thermocouples in their respective thermocouple installation cavities 186.

The second elbow portion 208 is generally perpendicular to the first elbow portion, and also includes a melt passageway 148B that extends through a free end thereof and interconnects with the melt passageway 148A of the first elbow portion at substantially right angles thereto. An annular planar front face at the free end of the second elbow portion 208 provides a mating face 220 that is configured to cooperate with a complementary mating face on the drop manifold 172, as will be described hereinafter. Also shown is a shallow diametrical relief in the outer surface of the second elbow portion 208 that provides a seat for receiving the melt conduit coupler 180.

In further detail, the melt conduit coupler seat includes a spigot coupling portion 76 which is provided along an outer circumferential surface of the relief portion and a locating shoulder 79 which retains the melt conduit coupler adjacent the free end of the second elbow portion 208. As with the first elbow portion 206, the second elbow portion 208 is configured to receive a heater 50 for maintaining the temperature of the melt within the melt passageway 148B at the prescribed operating temperature. Also, there is preferably a thermocouple installation cavity provided along second elbow portion 208, for providing temperature feedback to the heater controller and the temperature controller for the melt conduit coupler 180.

The third elbow portion 210 is also preferably substantially perpendicular to the second elbow portion 208, and is generally coaxial with the first elbow portion 206. The third elbow portion 210 includes a shallow cylindrical bore that provides a seat 214 configured for receiving an axial insulator 108, as shown in FIG. 7. The axial insulator 108 functions to thermally insulate the supply manifold 172 from the cold manifold plate 64. The axial insulator 108 is also configured to assist in substantially locating the supply manifold 172 on a first axis, and is also configured to direct the longitudinally applied compressive force from the machine nozzle into the manifold plate 62. Accordingly, the axial insulators are preferably designed to withstand the separating forces due to melt pressures and the carriage force developed by the carriage cylinders. The third elbow portion 210 is preferably heated by a beater 50 located on the outer surface thereof to compensate for the heat lost to the cooled manifold plate 62.

The fourth elbow portion 212 is also generally perpendicular to the third elbow portion 210, and is substantially coaxial with the second elbow portion 208. The fourth elbow portion 212 includes an insulator stand 216 that is configured on the end face of a free end of the fourth elbow portion, and includes generally parallel sidewalls that are configured to cooperate with a complementary slot and a side insulator 106, as shown in FIG. 7. The side insulators 106 are also configured to cooperate with complementary seat provided in the manifold plate 64 to assist in positioning and thermally isolate the supply manifold 170. The fourth elbow portion 212 is preferably heated by a heater 50 located on the outer surface thereof to compensate for the heat lost to the cooled manifold plate 62.

As introduced hereinbefore, the location of the first elbow 206 (i.e. inlet portion) of the supply manifold 170 is preferably substantially fixed with respect to a first axis. With reference to FIG. 7, it can be seen that the location of the supply manifold 170 is substantially fixed, along the first axis, between the cooling ring 185 and the axial insulator 108 that are themselves located within seats provided in the backing plate 62 and in the manifold plates 64, respectively. Preferably, a cylindrical bore is provided through the backing plate 62 and provides a passageway 59 that provides clearance for the machine nozzle 44 and the first elbow portion 206 of supply manifold 170. In addition, an inner circumferential surface of the passageway 59 provides a cooling ring seat 204 that locates the cooling ring 185 and thereby locates the first elbow portion 206 of the supply manifold 170. Singularly, in the manifold plate 64 is a shallow cylindrical bore which provides an insulator pocket 69 and provides clearance for the third elbow portion 210 of the supply manifold 170. Preferably, there is another shallow cylindrical bore that is concentric with the insulator pocket 69 that provides a seat 114 for receiving the axial insulator 108. The axial insulator 108 is preferably fixed or retained into the insulator seat 114, and the insulator seat (in cooperation with the complementary insulator seat in the third elbow portion) substantially locates the third elbow portion 206 of the supply manifold.

In FIG. 7, the side insulator 106 is shown installed in an insulator seat 114 provided in the manifold plate 64 immediately adjacent a manifold pocket 65. The side insulator 106 is further configured to cooperate with the insulator stand 216 on the fourth elbow portion 212 to preferably thermally isolate the supply manifold 170 from the cooled manifold plate 64, to counteract, in use, any separation forces (e.g. reaction forces from melt flow within the melt passageway 148B) between the supply and drop manifold 170, 172, and to provide a limited degree of alignment for the supply manifold 170.

The drop manifold 172 is shown in FIGS. 9A and 9B. The drop manifold 172 is very similar in configuration to the supply manifold 170 and has a similar cross-like configuration with a first elbow portion 306, a second elbow portion 308, a third elbow portion 310, and a fourth elbow portion 312, respectively. The first elbow portion 306 is configured to be coupled to the second elbow portion 208 of the supply manifold 170.

Accordingly, the first elbow portion 306 includes a melt passageway 148C that extends through the free end thereof and along the length of the first elbow portion 306, and is interconnected with a melt passageway 148D that extends along the second elbow portion 308. As with the second elbow portion 208 of the supply manifold, the first elbow portion 306 of the drop manifold includes a diametrically relieved portion adjacent the free end that provides a seat for the melt conduit coupler 180. As explained previously, the seat preferably comprises a spigot coupling portion 76 and a locating shoulder 79. An annular planer face at the free end of the first elbow portion 306 provides a mating face 220 that cooperates with the complementary mating face on the supply manifold 170. The remaining outer portion of the first elbow portion 306 is configured to receive a heater 50 and one or more thermocouple installations 186, as explained previously.

The second elbow portion 308, or discharge portion, is substantially perpendicular to the first elbow portion 306. The second elbow portion 308 includes the melt passageway 148D that extends through the free end of the second elbow portion 308 and interconnects with the melt passageway 148C of the first elbow portion 306. The free end of the second elbow portion 308 is preferably configured to include a seat for receiving a spigot tip insert 145. Of course, the spigot tip insert could otherwise be made integrally with the second elbow portion as shown with reference to FIG. 11 wherein an alternative embodiment of the drop manifolds 172 and 172′ is shown. This spigot tip insert 145, as shown in FIG. 7, is configured to interconnect the drop manifold 172 with the sprue bushing 151 of the cold sprue 150. The seat provided through the free end of the second elbow portion 308 is provided by a shallow cylindrical bore, and an inner circumferential surface of the shallow bore provides a spigot coupling surface 176 that cooperates with an outer circumferential complementary spigot coupling portion 176′ on the spigot tip insert 145. Also, an annular shoulder provided at the base of the shallow cylindrical bore provides a locating shoulder 177 for locating the spigot tip insert 145 within the seat. The outer circumferential surface of the spigot tip insert 145 also provides a spigot coupling portion 147 that is configured to cooperate with a complementary spigot coupling portion 147′ provided in the sprue bushing 151. Through heat conduction to the cooled cavity plate assembly 66, a spigot seal is maintained between the complementary spigot interface portions 147, 147′ and also between the spigot coupling portions 176, 176′. The remaining outer surface of the second elbow portion 308 is preferably configured for receiving heaters 50, and includes one or more thermocouple installation cavities 186 for temperature feedback control of the beaters 50, as explained previously.

The third elbow portion 310 is configured similarly to the fourth elbow portion 212 of the supply manifold 170 and accordingly includes an insulator stand 216 for receiving the side insulator 106, as shown in FIG. 7. The side insulator 106 is shown to be installed in a insulator seat 114 provided in the manifold plate 64.

The fourth elbow portion 312 is configured similarly to the third elbow portion 210 of the supply manifold 170, and accordingly includes a insulator seat 214. The insulator seat 214 is preferably configured to receive an end of an axial insulator 110 that can be seen in FIG. 7. The axial insulator 110 is retained within a insulator seat 114 provided in the backing plate 62. Also shown configured in the backing plate 62 is a shallow cylindrical bore that provides an insulator pocket 69 for providing clearance around the fourth elbow portion 312 of the drop manifold 172. The insulator seat 114 is preferably configured as a concentric shallow cylindrical bore formed at the base of the insulator pocket 69. As before, the axial insulator 110 functions to thermally insulate the drop manifold 172 from the backing plate 62, transfer axial loads to the manifold plate 62, and to assist in positioning of the drop manifold 172 about the inlet of the cold sprue 150. In particular, with reference to FIG. 7, it can be seen that the location of the drop manifold 172 is substantially fixed, along the first axis, between the sprue bushing 151 and the axial insulator 110 that are themselves located within seats provided in the cavity plate 66 and in the backing plates 62, respectively.

Also shown in FIG. 7, the melt conduit coupler 180 is located within a seat 178 provided in the manifold plate 64. As described previously, the melt conduit coupler 180 is preferably retained within the seat 178 through the use of fasteners that pass through the cylindrical bores 194 in the melt conduit coupler 180, and cooperate with complementary portions in the manifold plate 64.

As explained previously with reference to FIGS. 3A, 3B, and 5, the spigot coupling portion 76 provided on the inner circumferential surface of the melt conduit coupler cooperates with the complementary spigot coupling portions 76′ of the free ends of the supply and drop manifolds 76 to provide a spigot seal therebetween. In the cold condition, there is preferably a cold clearance gap 116 between the mating faces 220 of the drop manifold 172 and the supply manifold 70. At operating temperatures, however, by virtue of the thermal growth of the manifolds, the mating faces of the manifolds will preferably meet to provide a supplemental face seal therebetween.

Also shown in FIG. 7 is an optional insulating plate 60 which thermally insulates the hot runner 26 from the relatively cool stationary platen 16 (FIG. 1) of the machine clamp 12.

With reference to FIGS. 10 and 11, another embodiment of the present invention is shown. In particular, the hot half 25 is configured to include a multi-drop hot runner 26. The drops of a multi-drop hot runner 26 may be used for servicing a large molding cavity or a multi-cavity mold. While the present embodiment is configured to include two vertically oriented drops, other quantities and configurations of drops are possible. In the present embodiment the molding inserts are not shown, but would otherwise have been mounted to a front face of the cavity plate assembly 27, or recessed therein. The cavity plate assembly 27 has been configured to include a quantity of two of the drop nozzle assembly 250, each of which is configured to couple the molding cavities (not shown) with the drop manifolds 172 and 172′. The structure and operation of such a drop nozzle assembly 250 is generally described with reference to the description of a sprue apparatus in pending PCT Application PCT/CA03/00303. The important difference, is that the drop nozzle assembly 250 is presently configured to couple with the drop manifolds 172 instead of a machine nozzle 44.

As shown with reference to FIG. 11, the drop nozzle assembly 250 comprises a sprue bushing 252, which is essentially a tubular melt conduit, that is housed between a front housing and a cooling insert 256.

The sprue bushing 252 is arranged within a front housing 254 such that a spigot ring portion 288, configured at the front of the sprue bushing 252, is received within a complementary spigot coupling portion provided in the front portion 290 of front housing 254. A rear portion of the sprue bushing 252 is received within a cooling insert 256 that is located within a rear portion of the front housing 254. The cooling insert 256 functions to cool an inlet portion of the sprue bushing 252 such that a spigot connection can be maintained between a spigot coupling portion 174, configured along an inner circumferential surface of a shallow cylindrical bore formed through the end of the sprue bushing 252, and the complementary spigot coupling portion disposed on the drop manifold 172.

Also shown is a plurality of heaters that are arranged along the length of the sprue bushing 252 to maintain the temperature of the melt within a melt passageway therein at a prescribed operating temperature.

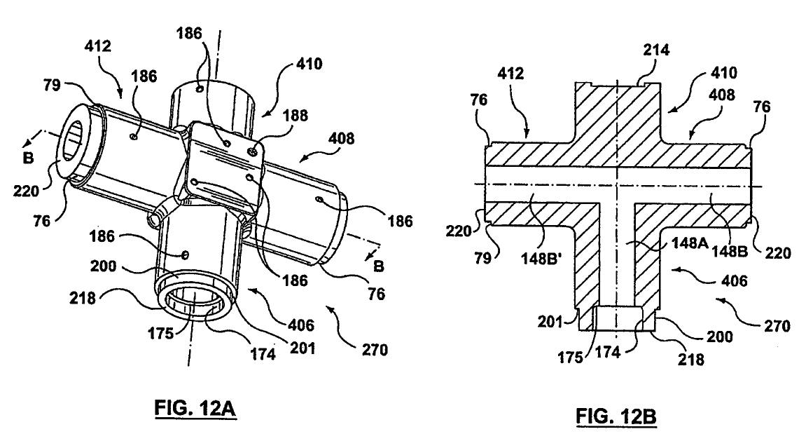

The configuration of the supply manifold 270 and drop manifolds 172, 172′ that are shown arranged between the manifold plate 64 and the manifold backing plate 62 with reference to FIG. 7 is substantially the same as that described with reference to the hot runner configuration (FIG. 7). As shown with reference to FIGS. 12A and 12B, a notable difference with respect to the supply manifold 270, relative to the that described previously and shown in FIGS. 8A and 8B, is that the fourth elbow portion 412 has been configured identically to the second elbow portion 408, including an additional melt passageway 143B′, and hence is configured for interconnection with the additional drop manifold 172′ adjacent thereto. To accommodate the extra drop manifold 172′, as shown in FIG. 11, there is provided an additional melt conduit coupler 180, drop passage 67, insulator pocket 69, and insulator installation 114.

As described hereinbefore, the hot runner 26 could be reconfigured to include any quantity and/or configuration of drops. Accordingly, many variations on the number and configuration of the manifolds are possible. For example, an intermediate manifold (not shown) could be configured between the supply and drop manifolds.

Any type of controller or processor may be used to control the temperature of the melt and structure, as described above. For example, one or more general-purpose computers, Application Specific Integrated Circuits (ASICs), Digital Signal Processors (DSPs), gate arrays, analog circuits, dedicated digital and/or analog processors, hard-wired circuits, etc., may receive input from the thermocouples described herein. Instructions for controlling the one or more of such controllers or processors may be stored in any desirable computer-readable medium and/or data structure, such floppy diskettes, hard drives, CD-ROMs, RAMs, EEPROMs, magnetic media, optical media, magneto-optical media, etc.

### Conclusion

Thus, what has been described (above) is a method and apparatus for the coupling of molding machine structures to provide enhanced sealing while allowing for the thermal expansion of the components. The individual components shown in outline or designated by blocks in the attached Drawings are all well-known in the injection molding arts, and their specific construction and operation are not critical to the operation or best mode for carrying out the invention.

### Other Non-Limiting Embodiments

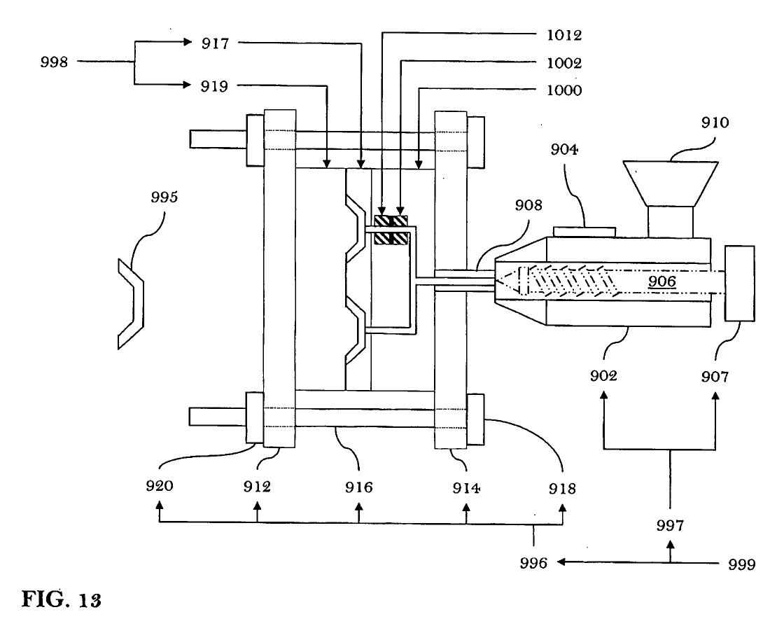

FIG. 13 depicts the schematic representation of the hot runner 1000 according to the another non-limiting embodiment, in which the hot runner 1000 is usable with a metal-injection molding system 999 (hereafter referred to as the “system 999”). The system 999 has: (i) an extruder 997 (known), and (ii) a clamp assembly 996 (known). The system 999 may include components that are known to persons skilled in the art, and these known components will not be described here; these known components are described, at least in part, in the following text books (by way of example): (i) “injection Molding Handbook” by Osswald/Turng/Gramann (ISBN: 3446-21669-2; publisher: Hanser), (ii) “Injection Molding Handbook” by Rosato and Rosato (ISBN: 0-412-99381-3; publisher: Chapman & Hill), and/or (iii) “Injection Molding Systems” 3rd Edition by Jobannaber (ISBN 3-446-17733-7). The extruder 997 may be: (i) a reciprocating-screw (RS) extruder, or (ii) a two-stage extruder that has a shooting-pot configuration Generally, the extruder 997 is configured to prepare and inject, under pressure, the metallic-molding material. The clamp assembly 996 is configured to: (i) support a mold 998 (known), and (ii) support the hot runner 1000. The hot runner 1000 is used for directing the metallic-molding material from the extruder 997 of the system 999 toward the mold 998. The system 999, the hot runner 1000 and/or mold 998 are sold separately or together.

The hot runner 1000 includes: (i) a first conduit 1002, and (U) a second conduit 1012. The first conduit 1002 is configured to receive the metallic-molding material. The second conduit 1012 is configured to receive the metallic-molding material from the first conduit 1002. For example, the first conduit 1002 is configured to receive the metallic-molding material under pressure from the extruder 997, and the second conduit 1012 is configured to: (i) receive the metallic-molding material from the first conduit 1002, and (ii) convey the metallic-molding material toward the mold 998. The mold 998 is used to mold a molded article 995.

The extruder 997 includes: (i) a hopper 910, (ii) a barrel 902, (iii) a heater 904, (iv) a screw 906, (v) a screw actuator 907, and (vi) a nozzle 908. The hopper 910 is connected with a feed throat of the barrel 902 so that the molding material may be conveyed into an interior of the barrel 902. The molding material in the hopper 910 is solidified but flowable particles of metallic chips. The screw 906 is received in the interior of the barrel 902. The nozzle 908 is coupled with an exit port of the barrel 902. The heater 904 is coupled with the barrel 902, so that heat may be transferred from the heater 904 through the barrel 902 to the molding material that is held in the interior of the barrel 902. A check valve (not depicted, but known) is attached to the tip of the screw 906. The check valve is used to: (i) accumulate a shot of the molding material in the accumulation zone of the barrel 902, which is located next to the exit port of the barrel 902, and (ii) to prevent back flow of the molding material back toward the feed throat located adjacent to the hopper 910. Before the metallic-molding material is processed during operation, a plug (not depicted, but known) is formed in the tip of the nozzle 908. The plug is used to block the flow of the metallic-molding material, and in this manner the metallic-molding material is accumulated in the accumulation zone of the barrel 902, once the extruder 997 begins processing the metallic-molding material, so that a shot of material may be accumulated with the help of the check valve.

In operation, the hopper 910 receives an alloy in a solid state preferably chips) of magnesium, aluminum or zinc, etc, and feeds the alloy to the barrel 902. The screw 906 is used to convey the chips forwardly from the feed throat past the check valve and toward the exit port of the barrel 902. Heat energy flows from the heater 904 through the barrel 902 to the alloy disposed in the interior of the barrel 902, so that the alloy may be melted into either a liquidus state or a semi-solid state (also called a slurry state). The melted alloy is hereafter referred to as the metallic-molding material or melt. The plug that is formed in the nozzle 908 prevents the metallic-molding material from leaving the barrel 902. However, once the screw actuator 907 is used to translate the screw 906 forwardly toward the exit port of the barrel 902, tie plug becomes blown out from the nozzle 908 due to the build up of pressure in the barrel 902, and then the metallic-molding material may be ejected, under pressure, from the barrel 902 and through the nozzle 908.

The clamp assembly 996 includes: (i) a movable platen 912, (ii) a stationary platen 914, (iii) rods 916, (iv) clamps 918, and (v) locks 920. The mold 998 includes: (i) a movable mold half 919, and (ii) a stationary mold half 917. The movable mold half 919 is mounted to the movable platen 912. The hot runner 1000 is mounted to the stationary platen 914. The stationary mold half 917 is mounted to the hot runner 1000, so that the movable mold half 919 faces the stationary mold half 917. The clamps 918 are mounted to respective corners of the stationary platen 914. The locks 920 are mounted to respective corners of the movable platen 912. Ends of the rods 916 are mounted with respective clamps 918, and the other ends of the rods 916 are lockably engagable and disengagable (that is, lockably interactable) with respective locks 920.

In operation, the movable platen 912 is movable relative to the stationary platen 914 by a platen-moving actuator (not depicted, but known) so that the movable mold half 919 may be closed against the stationary mold half 917. The locks 920 are used to lock the rods 916 to the movable platen 912 after the mold 998 is closed shut. The clamps 918 are used to apply a clamp force to the movable platen 912 and the stationary platen 914 after the rods are locked to the movable platen 912, and in this manner the clamping force may be transferred to the mold 998. The clamping force is used to keep the mold 998 shut while the extruder 997 injects, under pressure, the metallic-molding material into the mold 998, and in this manner the mold 998 is prevented from flashing while the mold 998 receives the metallic-molding material. Once the molded article 995 has formed and solidified in the mold 998, the clamping force is deactivated. The locks 920 are deactivated so that the rods 916 are no longer locked to the movable platen 912. A mold break force is applied to the mold 998 by a mold-break actuator (not depicted, but known) so that the mold 998 may be broken apart. Once the mold 998 is broken apart, the movable platen 912 is moved away from the stationary platen 914 so that the molded article may be removed from the mold 998 ether manually, by ejection rods (not depicted, but known) or by robot (not depicted, but known).

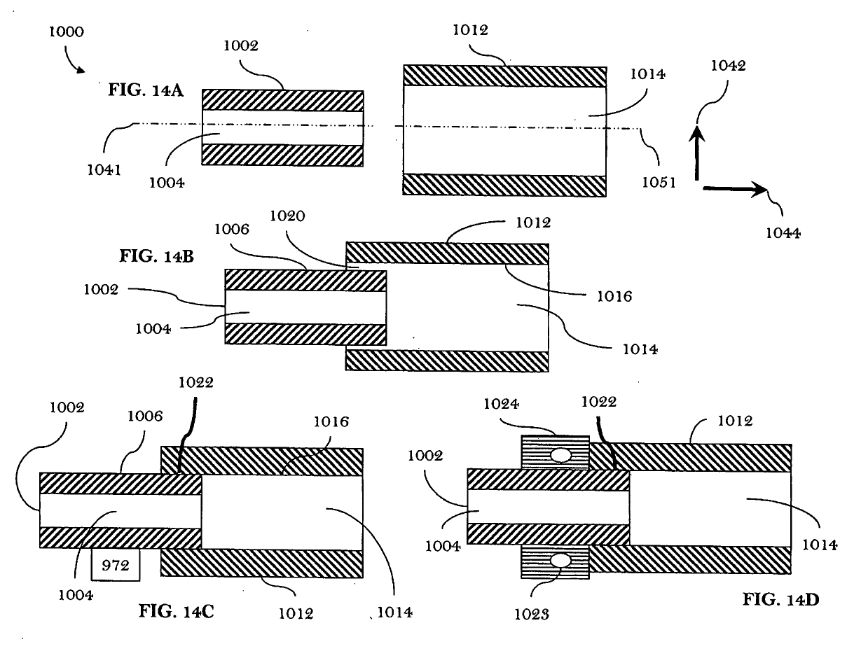

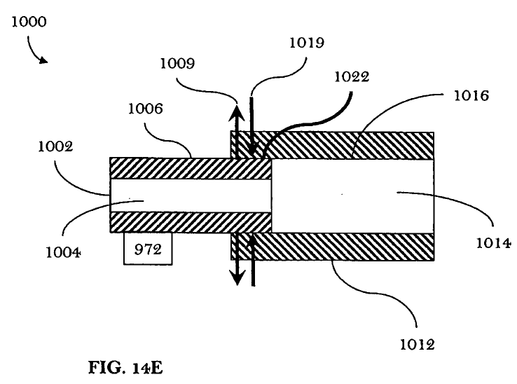

FIGS. 14A to 14E depict the cross-sectional views of the first non-limiting variant of the hot runner 1000 of FIG. 13. FIG. 14A depicts a non-assembled case, in which the first conduit 1002 is separated or is spaced apart from the second conduit 1012, so that the first conduit 1002 and the second conduit 1012 are not cooperatively assembled with each other. The first conduit 1002 defines a first passageway 1004 that is configured to convey the metallic-molding material. The second conduit 1012 defines a second passageway 1014 that is configured to convey the metallic-molding material. The second conduit 1012 is configured to receive the metallic-molding material from the first conduit 1002. The first conduit 1002 has a longitudinal axis 1041 that extends axially through the first conduit 1002. The second conduit 1012 has a longitudinal axis 1051 that extends axially through the second conduit 1012. The longitudinal axis 1041 and the longitudinal axis 1051 extend along a common axial direction 1044 once the first conduit 1002 and the second conduit 1012 are assembled (this case is depicted in FIGS. 14C, 14D and 14E). A radial direction 1042 extends perpendicularly from the common axial direction 1044. Once the first conduit 1002 and the second conduit 1012 are assembled (this case is depicted in FIGS. 14C, 14D and 14E), the metallic-molding material may then flow from the first passageway 1004 to the second passageway 1014.

FIG. 14B depicts a clearance-gap case, in which the first conduit 1002 and the second conduit 1012 are assembled so that a clearance gap 1020 is defined between the first conduit 1002 and the second conduit 1012. The clearance gap 1020 permits the first conduit 1002 to be assembled (that is, placed or located) with the second conduit 1012. The first conduit 1002 fits within or slides within the second conduit 1012. Specifically, the first conduit 1002 fits within the second passageway 1014 of the second conduit 1012. The first conduit 1002 includes an outer surface 1006, and the second conduit 1012 includes an inner surface 1016. The clearance gap 1020 is located between the outer surface 1006 of the first conduit 1002 and the inner surface 1016 of the second conduit 1012 (once the first conduit 1002 is inserted into the second conduit 1012).

FIG. 14C depicts a thermal-expansion case, in which the first conduit 1002 and the second conduit 1012 are operatively assembled. The first conduit 1002 is heated by a first heater 972 (hereafter referred to as the “heater 972”) that is coupled with the first conduit 1002, so that the first conduit 1002 may be allowed to thermally expand relative to the second conduit 1012 sufficiently enough so that the clearance gap 1020 is replaced by an interference seal 1022 that is formed between the first conduit 1002 and the second conduit 1012. The first conduit 1002 expands radially along the radial direction 1042. The interference seal 1022 substantially prevents the leakage of the metallic-molding material from the first conduit 1002 and the second conduit 1012. The first conduit 1002 is thermally expandable relative to the second conduit 1012 sufficiently enough so that an interference seal 1022 may form between the first conduit 1002 and the second conduit 1012. The heater 972 heats the first conduit 1002, and once the first conduit 1002 touches the second conduit 1012, the second conduit 1012 may be heated by the heater 972 as well so long as the thermal expansion of the second conduit 1012 does not cause the interference seal 1022 to become compromised (that is, broken). The interference seal 1022 is located between: (i) the outer surface 1006 of the first conduit 1002, and (ii) the inner surface 1016 of the second conduit 1012. Now that the interference seal 1022 is set up, the metallic-molding material may be made to flow (under pressure) through the first conduit 1002 and the second conduit 1012, and in this manner the metallic-molding material may flow, under pressure, from the extruder 997 to the mold 998 (depicted in FIG. 13).

FIG. 14D depicts the cross-sectional view of the first non-limiting variant of the hot runner 1000 of FIG. 13, in which the hot runner 1000 further includes a body 1024 that is located proximate to (or is seated adjacent to) the interference seal 1022. The body 1024 abuts: (i) the end portion of the second conduit 1012, and (ii) the outer surface 1006 of the first conduit 1002. The body 1024, which includes a cooling circuit 1023, acts to actively cool the interference seal 1022 so that for the case where interference seal 1022 fails, any leakage of the metallic-molding material that may pass by interference seal 1022 may be cooled sufficiently enough so that the leakage may be solidified and thus prevent further leakage. The body 1024 provides a back up protection for reducing inadvertent leakage for the case where the interference seal 1022 fails to block or prevent leakage of the metallic-molding material.

FIG. 14E depicts the thermal-expansion case, in which the first conduit 1002, which causes the first conduit 1002 to exert a thermal-expansion force 1009 (that is, radially) toward the second conduit 1012, and in response the second conduit 1012 exerts a reaction force 1019 against the thermal-expansion force 1009. The reaction force 1019 and the thermal-expansion force 1009 cooperate so as to maintain or improve the sealing effectiveness of the interference seal 1022.

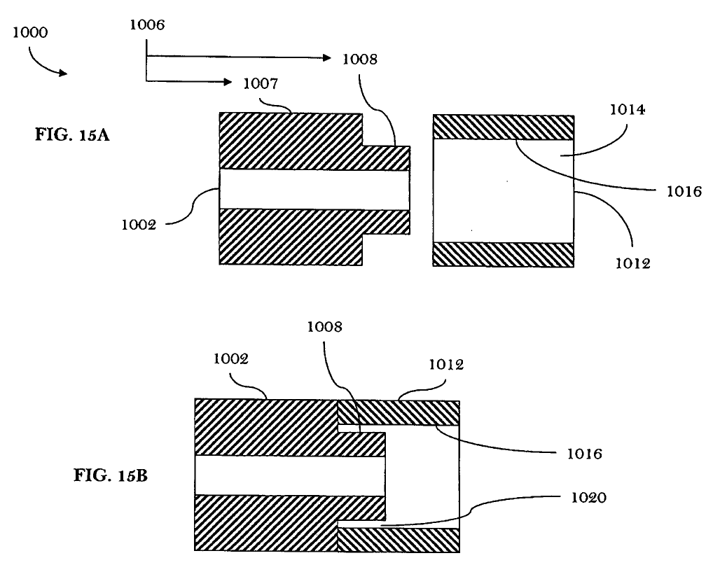

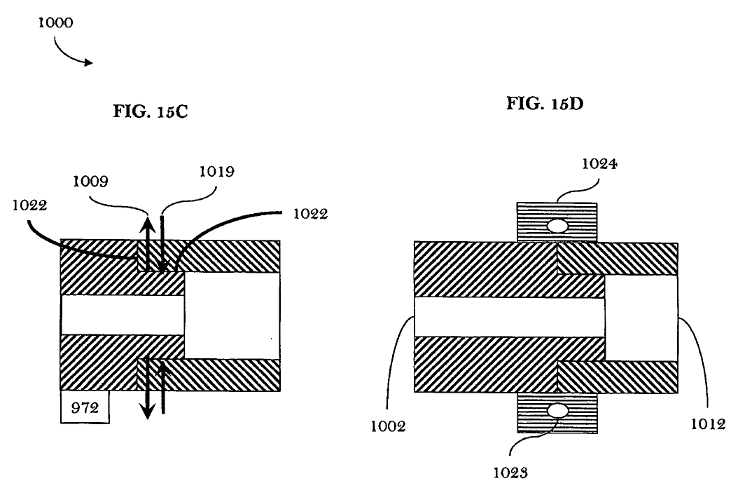

FIGS. 15A to 15D depict the cross-sectional views of the second non-limiting variant of the hot runner 1000 of FIG. 13. FIG. 15A depicts the non-assembled case, in which the first conduit 1002 and the second conduit 1012 are not operatively assembled with each other; that is, the first conduit 1002 and the second conduit 1012 are depicted offset from each other. The outer surface 1006 of the first conduit 1002 includes: (i) a first outer surface 1007; and (ii) a second outer surface 1008 that is located at an end of the first conduit 1002. The second outer surface 1008 is radially offset from the first outer surface 1007. The second conduit 1012 includes an inner surface 1016. The diameter associated with the second outer surface 1008 is smaller than the diameter associated with the first outer surface 1007 and in this manner, the first conduit 1002 forms a spigot that faces the end or the exit of the second conduit 1012.

FIG. 15B depicts the clearance-gap case, in which at least a portion of the second outer surface 1008 of the first conduit 1002 is inserted past the end of the second conduit 1012 and into the second passageway 1014. The clearance gap 1020 exists between the second outer surface 1008 of the first conduit 1002 and the inner surface 1016 of the second conduit 1012. Preferably (not necessarily), the shoulder portion of the first conduit 1002 abuts against an end of the second conduit 1012.

FIG. 15C depicts the thermal-expansion case, in which heat (from the heater 972) is applied to the first conduit 1002 so that the clearance gap 1020 is replaced with the interference seal 1022. The clearance gap 1020 is take up (or gone) because the first conduit 1002 has thermally expanded (radially) against the second conduit 1012. The interference seal 1022 is located between: (i) the second outer surface 1008 of the first conduit 1002, and (ii) the inner surface 1016 of the second conduit 1012.

FIG. 15D depicts a non-limiting variant, in which the body 1024 is positioned so as to overlap the first conduit 1002 and the second conduit 1012. The body 1024 is used for the case where the interference seal 1022 fails, and the body 1024 may then be used to actively cool off any leakage passing by the interference seal 1022.

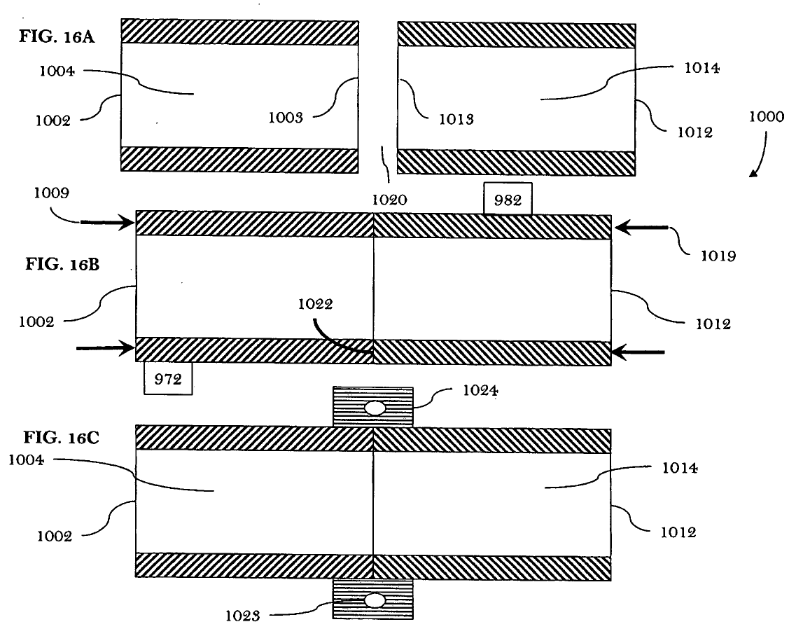

FIGS. 16A to 16C depict the cross-sectional views of the third non-limiting variant of the hot runner 1000 of FIG. 13. FIG. 16A depicts the non-assembled case and the clearance-gap case, in which the clearance gap 1020 is located between the ends of the first conduit 1002 and the second conduit 1012. The first conduit 1002 includes a first end 1003, and the second conduit 1012 includes a second end 1013 that faces the first end 1003 of the first conduit 1002.

FIG. 16B depicts the thermal-expansion case, in which the first end 1003 and the second end 1013 of first conduit 1002 and of the second conduit 1012 (respectively) have expanded axially toward each other. The axial expansion of the first conduit 1002 and the second conduit 1012 may be accomplished by using: (i) both the heater 972 and a second heater 982 (hereafter referred to as the “heater 982”), or (ii) one of the heater 972 or the heater 982. If one of the heaters 972 or 982 is used, one of the end of the first conduit 1002 or the second conduit 1012 (that is connected to one of the selected heaters 972 or 982) may expand toward the end of other conduit. The thermal-expansion force 1009 is exerted from the first end 1003 of the first conduit 1002 toward an end of the second conduit 1012. In response, the second end 1013 of the second conduit 1012 exerts the reaction force 1019 toward or against the thermal-expansion force 1009 so that the clearance gap 1020 (depicted in FIG. 16A) is now replaced with the interference seal 1022. The interference seal 1022 exists or is formed between: (i) the first end 1003 of the first conduit 1002, and (ii) the second end 1013 of the second conduit 1012.

FIG. 16C depicts a non-limiting variant, in which the body 1024 is placed so as to overlap (at least in pan) the first end 1003 and the second end 1013 of the first conduit 1002 and the second conduit 1012 (respectively), so that for the case where the interference seal 1022 becomes inadvertently broken, the body 1024 may actively cool off the metallic-molding material so as to prevent further leakage of the metallic-molding material from the first conduit 1002 and the second conduit 1012.

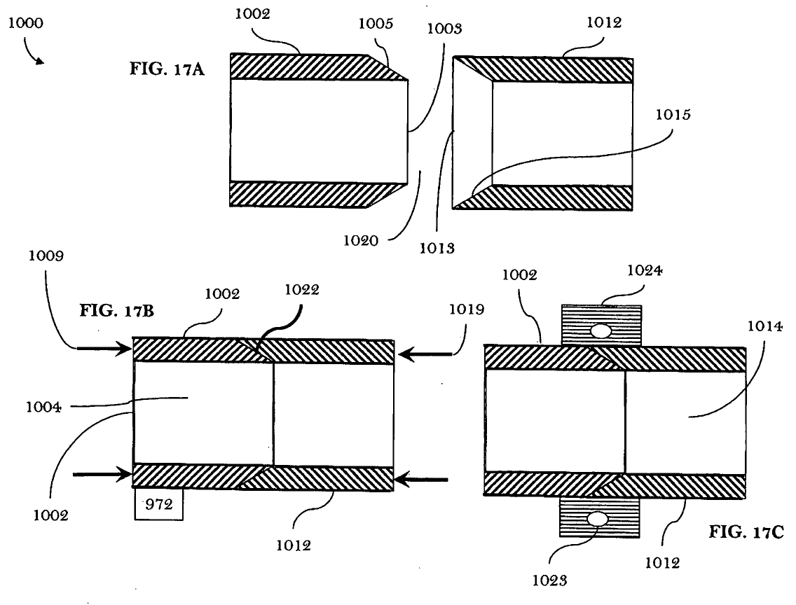

FIGS. 17A to 17C depict the cross-sectional views of the fourth non-limiting variant of the hot runner 1000 of FIG. 13. FIG. 17A depicts the non-assembled case and the clearance-gap case, in which the first end 1003 (of the first conduit 1002) has a first taper 1005. The second end 1013 (of the second conduit 1012) has a second taper 1015. The first taper 1005 and the second taper 1015 are complementary in shape and/or function with each other. The second end 1013 of the second conduit 1012 faces the first end 1003 of the first conduit 1002. The clearance gap 1020 exists between the ends of the first conduit 1002 and the second conduit 1012.

FIG. 17B depicts thermal-expansion case, in which the heater 972 (that is coupled with the first conduit 1002) is activated so that the first conduit 1002 may thermally expand so that the first end 1003 of the first conduit 1002 and the second end 1013 of the second conduit 1012 touch and press against each other along the axial directions of the first conduit 1002 and the second conduit 1012. In this manner, the interference seal 1022 may be formed between: (i) the first taper 1005 of the first end 1003 of the first conduit 1002, and (ii) the second taper 1015 of the second end 1013 of the second conduit 1012.

FIG. 17C depicts a non-limiting variant, in which the body 1024 acts as a back up for solidifying any leakage that may occur if the interference seal 1022 becomes inadvertently broken or fails.

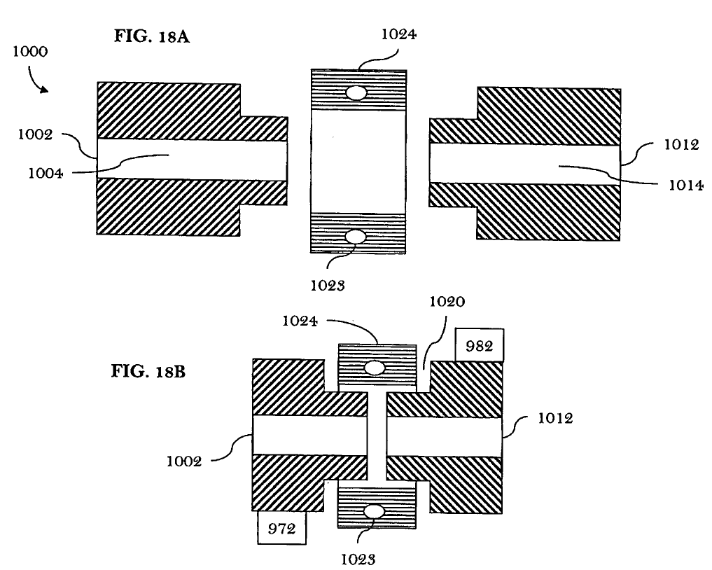

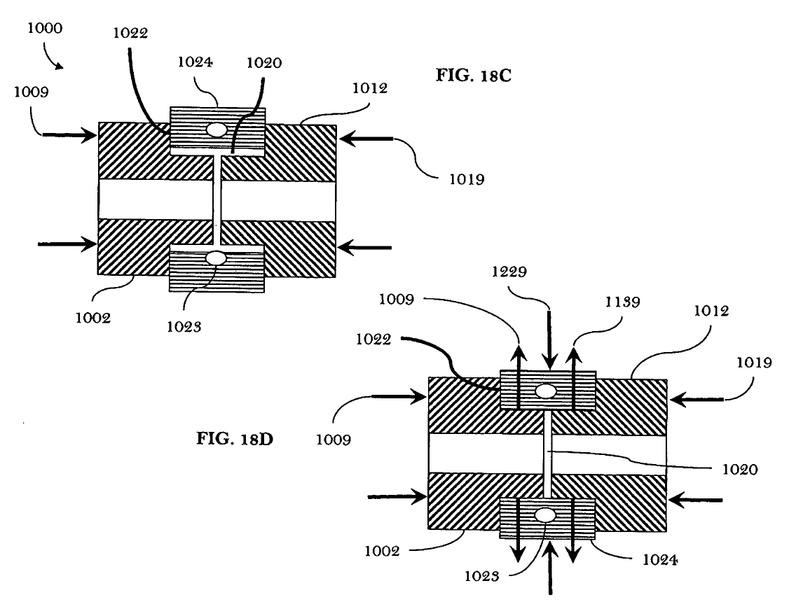

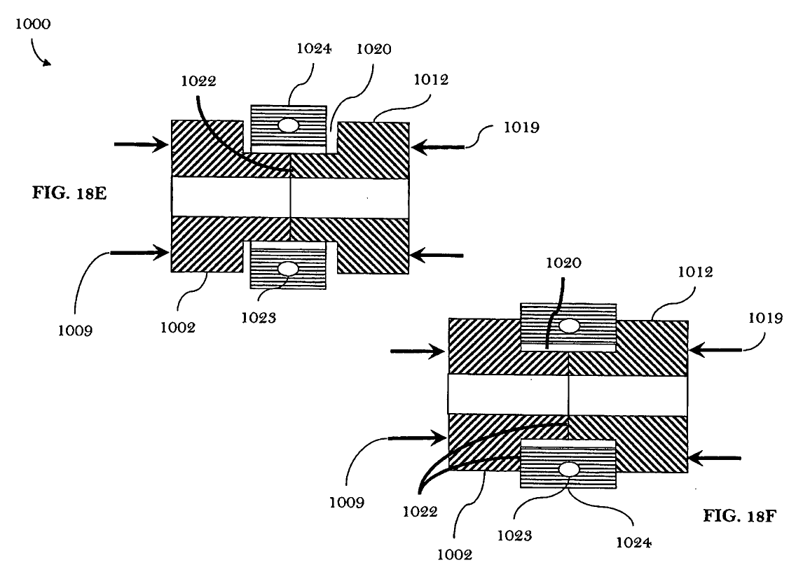

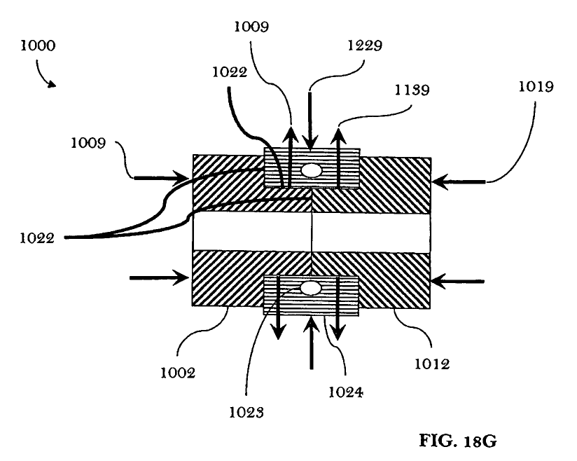

FIGS. 18A to 18D depict the cross-sectional views of the fifth non-limiting variant of the hot runner 1000 of FIG. 13. FIGS. 18A and 18B depict the non-assembled case and the clearance-gap case, respectively, in which the hot runner 1000 finer includes a body 1024 that is located: (i) proximate of the first conduit 1002 and the second conduit 1012, and (ii) outside of the first conduit 1002 and the second conduit 1012. The first conduit 1002 fits within the body 1024, and the second conduit 1012 fits within the body 1024 so that the clearance gap 1020 is located, in combination, between the body 1024, the first conduit 1002 and the second conduit 1012. The heaters 972 and 982 are mounted to the first conduit 1002 and the second conduit 1012 respectively.

FIG. 18C depicts the thermal-expansion case, in which heat is applied to the first conduit 1002 and the second conduit 1012 so that the first conduit 1002 and the second conduit 1012 may expand axially. In this manner, the interference seal 1022 is located between: (i) the first conduit 1002 and the body 1024, and (ii) the second conduit 1012 and the body 1024. The heaters 972 and 982 are used to heat the first conduit 1002 and the second conduit 1012 respectively. In response, (i) the first conduit 1002 expands so that a shoulder of the first conduit 1002 touches the end of the body 1024, and (ii) the second conduit 1012 expands so that a shoulder of the second conduit 1012 touches another end of the body 1024. However, the ends of the first conduit 1002 and the second conduit 1012 do not touch each other (for this arrangement). The first conduit 1002 exerts the thermal-expansion force 1009 along an axial direction through the first conduit 1002, through the end of the first conduit 1002, to the body 1024. The body 1024 transfers the thermal-expansion force 1009 over to the end of the second conduit 1012. In response, the second conduit 1012 exerts a reaction force 1019 back toward the body 1024, and then the body 1024 transfers the reaction force 1019 back to the first conduit 1002. Optionally, the body 1024 acts to cool the interference seal 1022 so that any inadvertent leakage of the metallic-molding material from the interference seal 1022 is cooled sufficiently enough so that the flow of leakage may be solidified or stopped.

FIG. 18D depicts the thermal-expansion case, in which: (i) the first conduit 1002 thermally expands in the radial and axial directions so that in this manner the first conduit 1002 touches the axial end of the body 1024, and (ii) the second conduit 1012 expands in the radial and axial directions so that in this manner the second conduit 1012 touches the axial end of the body 1024; the ends of the first conduit 1002 and the second conduit 1012 do not touch each other. In this case, the first conduit 1002 exerts the thermal-expansion force 1009: (i) along an axial direction, and (ii) a radial direction; along the axial direction, the second conduit 1012 exerts the reaction force 1019 back toward the first conduit 1002, and along the radial direction, the body 1024 responds by exerting a reaction force 1229 against the thermal-expansion force 1009 that is directed along the radial direction from the first conduit 1002. In this case, the second conduit 1012 exerts a thermal-expansion force 1139 along the radial direction, and in response the body 1024 exerts the reaction force 1229 back against the second conduit 1012. It will be appreciated that the second conduit 1012 will also exert a thermal expansion force (not depicted) axially toward the first conduit 1002, and in response the first conduit 1002 will exert a reaction force (not depicted) toward the second conduit 1012.

FIG. 18E depicts the thermal-expansion case, in which the first conduit 1002 touches the second conduit 1012, and the body 1024 does not touch the ends of the first conduit 1002 and the second conduit 1012. Naturally, the body 1024 will rest on the ends of the first conduit 1002 and the second conduit 1012 unless a means for supporting (not depicted) the body 1024 is used to keep the body 1024 offset from the first conduit 1002 and the second conduit 1012 (as depicted in FIG. 18E). In this case, one of the heaters 972 and 982 is used or both of the heaters 972 and 982 are used. The interference seal 1022 is located between: (i) the first conduit 1002, and (ii) the second conduit 1012. The first conduit 1002 exerts the thermal-expansion force 1009 against the second conduit 1012, and in response the second conduit 1012 exerts the reaction force 1019 against the first conduit 1002. The body 1024 does not have to touch, in a sealing manner, with the first conduit 1002 or the second conduit 1012.

FIG. 18F depicts the thermal/expansion case, in which: (i) the end of the first conduit 1002 touches the end of the second conduit 1012, and (ii) the ends of the body 1024 touch and seal against the ends of the first conduit 1002 and the second conduit 1012. The first conduit 1002 exerts the thermal-expansion force 1009 against the second conduit 1012, and in response the second conduit 1012 exerts the reaction force 1019 against the first conduit 1002. In this case, the thermal-expansion force 1009 and the reaction force 1019 may pass through the body 1024.

FIG. 18G depicts the thermal-expansion case, in which the body 1024 abuts and seals against the first conduit 1002 and the second conduit 1012. The interference seal 1022 is located, at least in part, between: (i) the first conduit 1002 and the body 1024, (ii) the second conduit 1012 and the body 1024, and (iii) the first conduit 1002 and the second conduit 1012. In this case, the thermal-expansion forces 1009 and 1139 are set up along the radial direction, and the thermal-expansion force 1009 is set up along the axial direction. An in response, the reaction force 1229 acts along the radial direction and the reaction force 1019 acts along the axial direction.

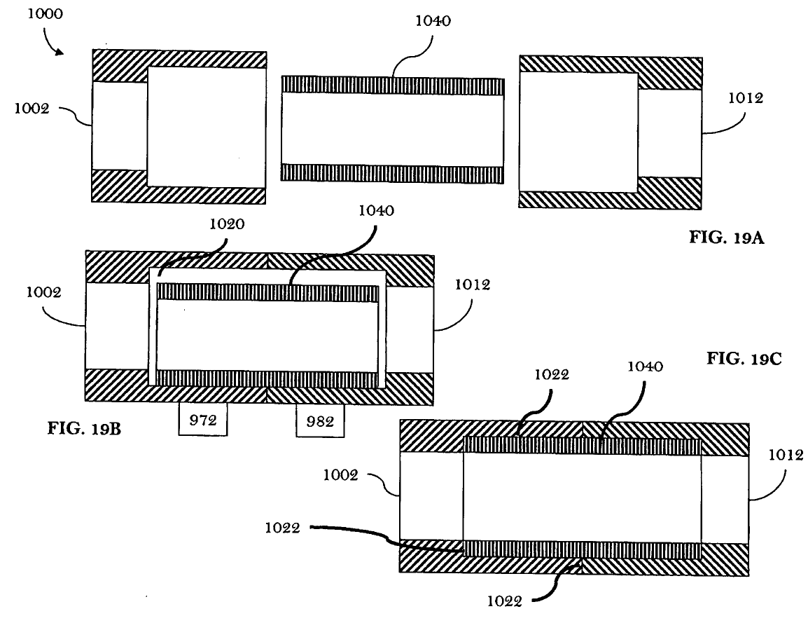

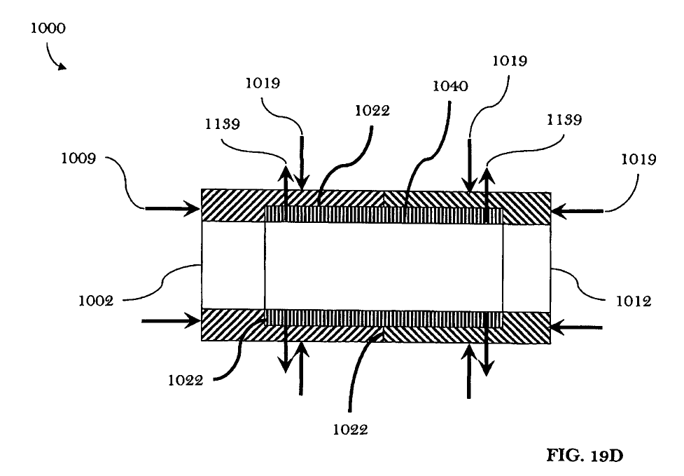

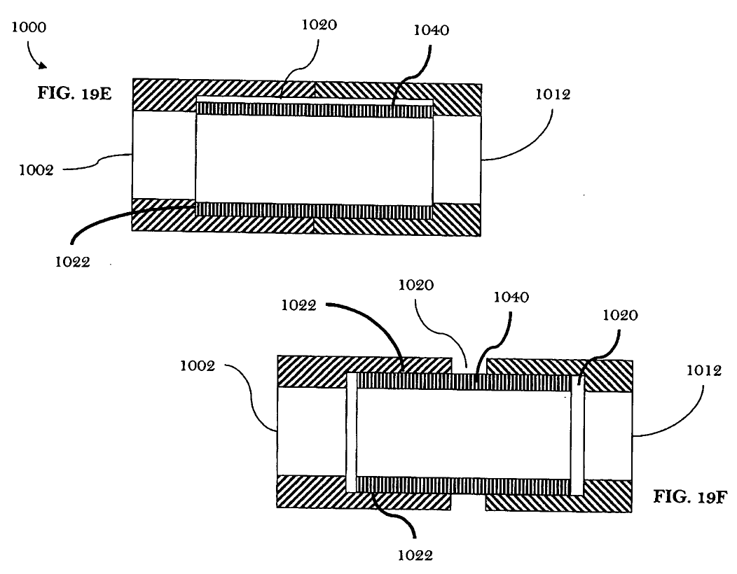

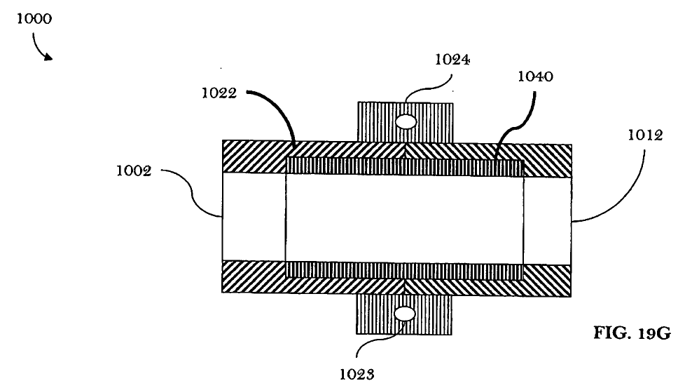

FIGS. 19A to 19C depict the cross-sectional views of the sixth non-limiting variant of the hot runner 1000 of FIG. 13. The first conduit 1002 and the second conduit 1012 define a recess or a bore along the ends of the first conduit 1002 and the second conduit 1012 that is configured to receive the body member 1040. FIG. 19A depicts the non-assembled case, in which the hot runner 1000 further includes a body member 1040 that is located: (i) proximate of the first conduit 1002 and the second conduit 1012, and (it) inside of the first conduit 1002 and the second conduit 1012.

FIG. 19B depicts the clearance-gap case, in which the first conduit 1002 and the second conduit 1012 abut against each other, and the body member 1040 overlaps, at least in part, the ends of the first conduit 1002 and the second conduit 1012. The body member 1040 rests on the first conduit 1002 and the second conduit 1012. The clearance gap 1020 is located between the body member 1040 and the first conduit 1002 and the second conduit 1012.

FIG. 19C depicts the thermal-expansion case, in which the heaters 972 and 982 transfer heat to the body member 1040 via the first conduit 1002 and the second conduit 1012. The thermal expansion of the body member 1040 is greater than the thermal expansion of the first conduit 1002 and the second conduit 1012. In response to being heated, the body member 1040 expanded radially and axially until the body member 1040 is made to touch and abut the first conduit 1002 and the second conduit 1012. The interference seal 1022 is located, at least in part, between: (i) the first conduit 1002 and the body member 1040, (ii) the second conduit 1012 and the body member 1040, and (iii) the first conduit 1002 and the second conduit 1012.

FIG. 19D depicts the thermal-expansion force 1009 that is exerted axially by the first conduit 1002 toward the second conduit 1012, and in response the second conduit 1012 exerts the reaction force 1019 back toward the first conduit 1002. The thermal/expansion force 1139 is exerted radially by the body member 1040, and in response the first conduit 1002 and the second conduit 1012 exert the reaction force 1019 back toward the body member 1040.

FIG. 19E depicts the cross-sectional view of the sixth non-limiting variant of the hot runner 1000 of FIG. 13, in which the interference seat 1022 is located between the axial ends of: (i) the first conduit 1002, and (ii) the second conduit 1012. For this case, the clearance gap 1020 exists, at least in part, radially between body member 1040 and the first conduit 1002 and the second conduit 1012, and the clearance gap 1020 as depicted does not leak the metallic-molding material.

FIG. 19F depicts the cross-sectional view of the sixth non-limiting variant of the hot runner 1000 of FIG. 13, in which the interference seal 1022 is located radially between: (i) the first conduit 1002 and the body member 1040, and (ii) the second conduit 1012 and the body member 1040. For this case, the clearance gap 1020 exists, at least in part, axially between: (i) the shoulder of the first conduit 1002 and the body member 1040, (ii) the shoulder of the second conduit 1012 and the body member 1040, and (i) the ends of the first conduit 1002 and the second conduit 1012 (the ends may touch each other).

FIG. 19G depicts the cross-sectional view of the sixth non-limiting variant of the hot runner 1000 of FIG. 13, in which the hot runner 1000 further includes a body 1024 that is located proximate to the interference seal 1022. The body 1024 is configured to cool the interference seal 1022 so that the leakage of the metallic-molding material is cooled sufficiently enough so that the leakage is solidified.

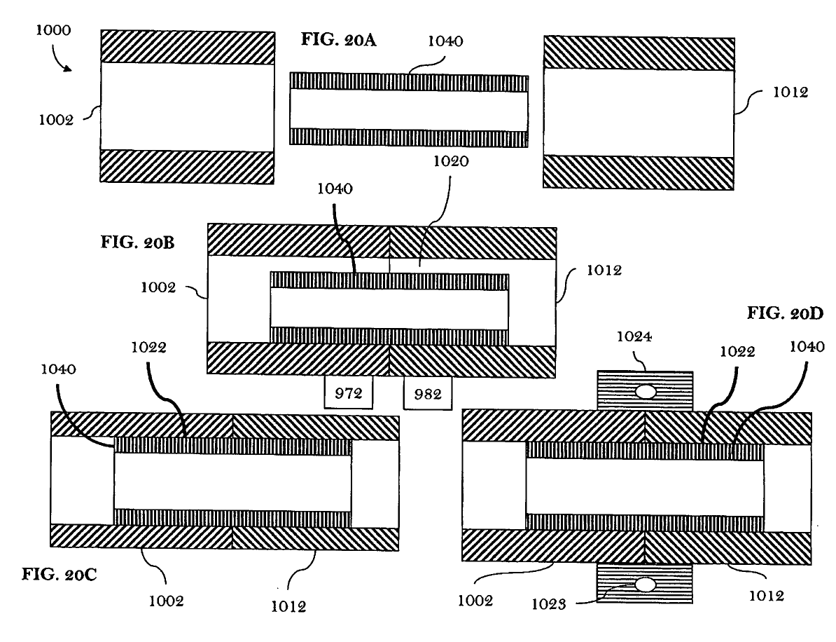

FIGS. 20A to 20D depict the cross-sectional views of the seventh non-limiting variant of the hot runner 1000 of FIG. 13. FIG. 20A depicts the non-assembled case, in which the first conduit 1002 and the second conduit 1012 are not assembled.

FIG. 20B depicts the clearance-gap case, in which the body member 1040 is received in both of the first conduit 1002 and the second conduit 1012, so that the body member 1040 overlaps the ends of the first conduit 1002 and the second conduit 1012 at least in part. For this case, the body member 1040 rests one the inner surfaces of the first conduit 1002 and the second conduit 1012 at least in part. The heaters 972 and 982 are coupled with the first conduit 1002 and the second conduit 1012 respectively. The clearance gap 1020 exists axially between the body member 1040 and the first conduit 1002 and the second conduit 1012. FIG. 20C depicts the thermal-expansion case, in which the body member 1040 received heat from the heaters 972 and 982 via the first conduit 1002 and the second conduit 1012 respectively, so that the body member 1040 expands anally so that the body member 1040 is made to abut the inner surfaces of the first conduit 1002 and the second conduit 1012. In this manner, the clearance gap 1020 is replaced with the interference seal 1022, which is located between the outer surface of the body member 1040 and the inner surfaces of the first conduit 1002 and the second conduit 1012. In the manner that is similar to FIG. 19D, the thermal-expansion force (not depicted) is exerted radially by the body member 1040 toward the first conduit 1002 and the second conduit 1012, and in response the first conduit 1002 and the second conduit 1012 exert the reaction force (not depicted) back toward the body member 1040.

FIG. 20D depicts the variant in which the body 1024 is used as a back up for solidifying any inadvertent leakage that may flow from the first conduit 1002 and the second conduit 1012 for the case where the interference seal 1022 has inadvertently broken.

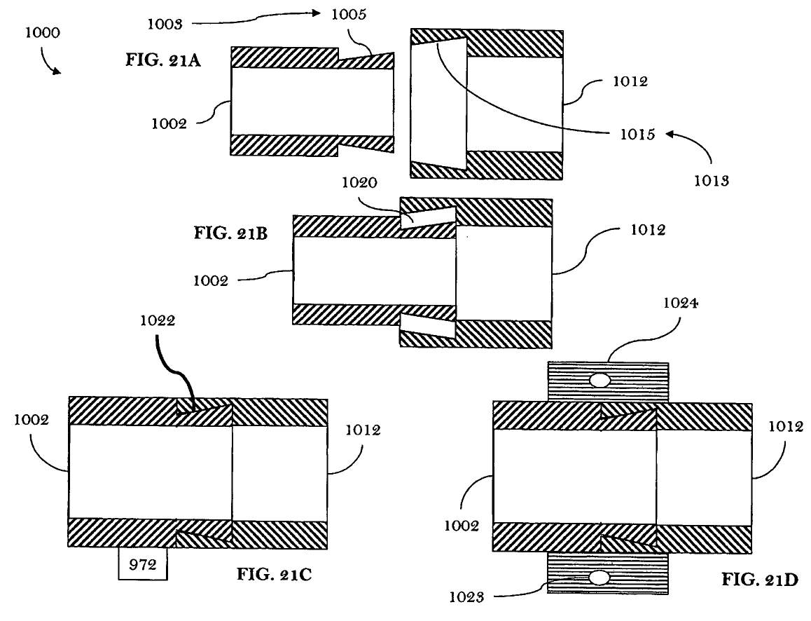

FIGS. 21A to 21D depict cross-sectional views of the eighth non-limiting variant of the hot runner 1000 of FIG. 13. FIG. 21A depicts the non-assembled case. The first conduit 1002 includes the first end 1003 that has the first taper 1005. The second conduit 1012 includes a second end 1013 that has the second taper 1015. The second end 1013 faces the first end 1003. The first taper 1005 and the second taper 1015 are complementary with each other. The first taper 1005 is receivable in the end of the second conduit 1012. The first taper 1005 and the second taper 1015 are aligned axially from the ends of the first conduit 1002 and the second conduit 1012. The first taper 1005 flares radially outward from the first end 1003 of the first conduit 1002. The second taper 1015: (i) flares-radially inward from the second end 1013 of the second conduit 1012, and (ii) is defined within the inner surface of the end of the second conduit 1012.

FIG. 21B depicts the clearance-gap case, in which the end of the first conduit 1002 is received in the end of the second conduit 1012. The clearance gap 1020 is defined between the first taper 1005 and the second taper 1015.

FIG. 21C depicts the thermal-expansion case, in which the beater 972 (which is coupled to the first conduit 1002) heats the first conduit 1002 so that the end of the first conduit 1002 thermally expands, and in response the first taper 1005 abuts the second taper 1015. In this manner, the clearance gap 1020 is replaced by the interference seal 1022. The interference seal 1022 exists between: (i) the first taper 1005 of the first end 1003 of the first conduit 1002, and (ii) the second taper 1015 of the second end 1013 of the second conduit 1012.

FIG. 21D depicts an optional variant, in which the body 1024 overlaps the first conduit 1002 and the second conduit 1012. The body 1024 is used to solidify leakage that may inadvertently escape from the interference seal 1022.

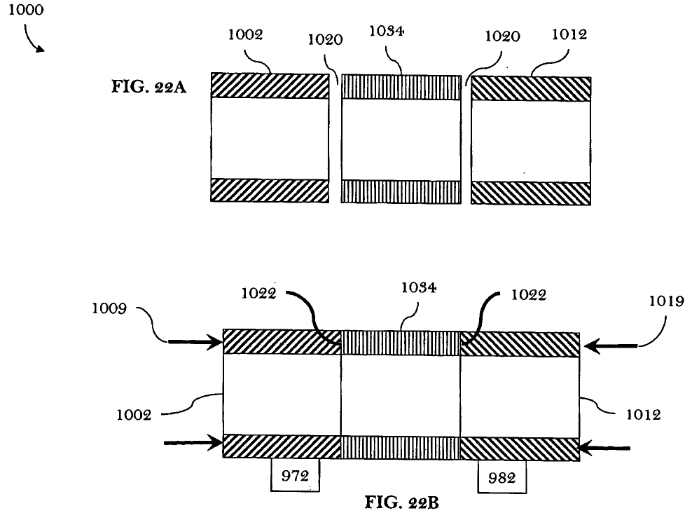

FIGS. 22A and 22B depict the cross-sectional views of the ninth non-limiting variant of the hot runner 1000 of FIG. 13. FIG. 22A depicts the non-assembled case and the clearance-gap case, in which the hot runner 1000 further includes an elastically-deformable body 1034 that is interposed or positioned between the first conduit 1002 and the second conduit 1012. The clearance gap exists 1020 between the elastically-deformable body 1034 and the ends of the first conduit 1002 and the second conduit 1012.

FIG. 22B depicts the thermal-expansion case, in which the heaters 972 and 982 that are coupled to the first conduit 1002 and the second conduit 1012, respectively, apply heat to the first conduit 1002 and the second conduit 1012 so that the ends of the first conduit 1002 and the second conduit 1012 may expand axially toward each other, until the clearance gap 1020 is replaced by the interference seal 1022. The interference seal 1022 is located between: (i) the end of the first conduit 1002 and the (axial) end of the elastically-deformable body 1034, and (ii) the (axial) end of the second conduit 1012 and the end of the elastically-deformable body 1034. The first conduit 1002 is configured to exert a thermal-expansion force 1009 toward the second conduit 1012 through the elastically-deformable body 1034. In response, the second conduit 1012 is configured to exert a reaction force 1019 against the thermal-expansion force 1009 through the elastically-deformable body 1034. The reaction force 1019 and the thermal-expansion force 1009 cooperate so as to maintain the interference seal 1022 between: (i) the elastically-deformable body 1034 and the first conduit 1002, and (ii) the elastically-deformable body 1034 and the second conduit 1012.

The description of the non-limiting embodiments provides ton-limiting examples of the present invention; these non-limiting examples do not limit the scope of the claims of the present invention. The non-limiting embodiments described are within the scope of the claims of the present invention. The non-limiting embodiments described above may be: (i) adapted, modified and/or enhanced, as may be expected by persons skilled in the art, for specific conditions and/or functions, without departing from the scope of the claims herein, and/or (ii) further extended to a variety of other applications without departing from the scope of the claims herein. It is to be understood that the non-limiting embodiments illustrate the aspects of the present invention. Reference herein to details and description of the non-limiting embodiments is not intended to limit the scope of the claims of the present invention. Other non-limiting embodiments, which may not have been described above, may be within the scope of the appended claims. It is understood that: (i) the scope of the present invention is limited by the claims, (ii) the claims themselves recite those features regarded as essential to the present invention, and (ii) preferable embodiments of the present invention axe the subject of dependent claims.

Therefore, what is to be protected by way of Letters Patent are limited only by the scope of the following claims:

1. A hot runner for conveying a metallic-molding material, the hot runner comprising:
a first conduit being configured to receive the metallic-molding material; and
a second conduit being configured to receive the metallic-molding material from the first conduit, the first conduit being thermally expandable relative to the second conduit sufficiently enough so that a clearance gap that is located between the first conduit and the second conduit is replaced by an interference seal that is formed between the first conduit and the second conduit, the interference seal substantially preventing a leakage of the metallic-molding material from the first conduit and the second conduit.

2. The hot runner of claim 1, wherein:
the first conduit defines a first passageway being configured to convey the metallic-molding material; and
the second conduit defines a second passageway being configured to convey the metallic-molding material, so that the metallic-molding material may flow from the first passageway to the second passageway,
in a clearance-gap case, the clearance gap exists between the first conduit and the second conduit, the clearance gap permitting the first conduit to be assembled with the second conduit, and
in a thermal-expansion case, the first conduit thermally expands relative to the second conduit sufficiently enough so that the clearance gap is replaced by the interference seal between the first conduit and the second conduit, the interference seal substantially preventing the leakage of the metallic-molding material from the first conduit and the second conduit.

3. The hot runner of claim 1, wherein:
the first conduit includes:
an outer surface;
the second conduit includes:
an inner surface; and
the interference seal is located between:
the outer surface of the first conduit, and
the inner surface of the second conduit.

4. The hot runner of claim 1, wherein:
the first conduit exerts a thermal-expansion force toward the second conduit, and
the second conduit exerts a reaction force against the thermal-expansion force, the reaction force and the thermal-expansion force maintaining the interference seal.

5. The hot runner of claim 1, further comprising:
a body being located proximate to the interference seal, the body cooling the interference seal so that the leakage of the metallic-molding material is cooled sufficiently enough so that the leakage is solidified.

6. The hot runner of claim 1, wherein:
the first conduit includes:
an outer surface, including:
a first outer surface; and
a second outer surface located at an end of the first conduit, and the
second outer surface being offset from the first outer surface; and
the second conduit includes:
an inner surface;
the interference seal is located between:
the second outer surface of the first conduit, and
the inner surface of the second conduit.

7. The hot runner of claim 1, wherein:
the first conduit includes:
a first end;
the second conduit includes:
a second end facing the first end of the first conduit; and
the interference seal exists between:
the first end of the first conduit, and
the second end of the second conduit.

8. The hot runner of claim 1, wherein:
the first conduit includes:
a first end having a first taper;
the second conduit includes:
a second end having a second taper, the second end facing the first end of the first conduit; and
the interference seal exists between:
the first taper of the first end of the first conduit and
the second taper of the second end of the second conduit.

9. The hot runner of claim 1, further comprising:
a body being located:
proximate of the first conduit and the second conduit, and
outside of the first conduit and the second conduit,
wherein:
the interference seal is located between:
the first conduit and the body, and
the second conduit and the body.

10. The hot runner of claim 1, further comprising:
a body being located:
proximate of the first conduit and the second conduit, and
outside of the first conduit and the second conduit,
wherein:
the interference seal is located between:
the first conduit, and
the second conduit.

11. The hot runner of claim 1, further comprising:
a body being located:
proximate of the first conduit and the second conduit, and
outside of the first conduit and the second conduit,
wherein:
the interference seal is located, at least in part, between:
the first conduit and the body,
the second conduit and the body, and
the first conduit and the second conduit.

12. The hot runner of claim 9, wherein:
the body is located proximate to the interference seal, the body cooling the interference seal so that the leakage of the metallic-molding material is cooled sufficiently enough so that the leakage is solidified.

13. The hot runner of claim 1, further comprising:
a body member being located:
proximate of the first conduit and the second conduit, and
inside of the first conduit and the second conduit,
wherein:
the interference seal located, at least in part, between:
the first conduit and the body member,
the second conduit and the body member, and
the first conduit and the second conduit.

14. The hot runner of claim 1, further comprising:
a body member being located:
proximate of the first conduit and the second conduit, and
inside of the first conduit and the second conduit,
wherein:
the interference seal located between:
the first conduit, and
the second conduit.

15. The hot runner of claim 1, further comprising:
a body member being located:
proximate of the first conduit and the second conduit, and
inside of the first conduit and the second conduit,
wherein:
the interference seal is located between:
the first conduit and the body member, and
the second conduit and the body member.

16. The hot runner of claim 13, further comprising:
a body being located proximate to the interference seal, the body cooling the interference seal so that the leakage of the metallic-molding material is cooled sufficiently enough so that the leakage is solidified.

17. The hot runner of claim 13, wherein:
the first conduit and the second conduit define a recess, the recess being configured to receive the body member.

18. The hot runner of claim 15, wherein:
the first conduit and the second conduit abut the body member.

19. The hot runner of claim 1, wherein:
the first conduit includes:
a first end having a first taper;
the second conduit includes:
a second end having a second taper, the second end facing the first end of the first conduit; and
the interference seal exists between:
the first taper of the first end of the first conduit and
the second taper of the second end of the second conduit,
the first taper flaring radially outward from the first end, and
the second taper flaring radially inward from the second end.

20. The hot runner of claim 1, further comprising:
an elastically-deformable body being interposed between the first conduit and the second conduit.

21. The hot runner of claim 1, further comprising:
an elastically-deformable body being interposed between the first conduit and the second conduit,
the first conduit is configured to exert a thermal-expansion force toward the second conduit through the elastically-deformable body,
the second conduit is configured to exert a reaction force against the thermal-expansion force through the elastically-deformable body, the reaction force and the thermal-expansion force maintaining the interference seal between:
the elastically-deformable body and the first conduit, and
the elastically-deformable body and the second conduit.

22. A metal-injection molding system, comprising:
an extruder being configured to prepare and inject, under pressure, the metallic-molding material; and
a clamp assembly being configured to support:
a mold, and
the hot runner of claim 1, the hot runner for directing the metallic-molding material from the extruder toward the mold.
